(19) United States
(12) Patent Application Publication
(10) Pub. No.: US 2025/0247809 A1
(43) Pub. Date: Jul. 31, 2025

(54) NAS LAYER OVERHEAD REDUCTION FOR IOT NTN

(71) Applicant: QUALCOMM Incorporated, San Diego, CA (US)

(72) Inventors: Amer CATOVIC, San Diego, CA (US); Osama LOTFALLAH, San Diego, CA (US); Umesh PHUYAL, San Diego, CA (US); Lenaig Genevieve CHAPONNIERE, La Jolla, CA (US)

(21) Appl. No.: 19/041,889

(22) Filed: Jan. 30, 2025

Related U.S. Application Data
(60) Provisional application No. 63/627,748, filed on Jan. 31, 2024.

(51) Int. Cl. H04W 60/04; H04W 8/22; H04W 76/30

(52) U.S. Cl. CPC H04W 60/04; H04W 8/22; H04W 76/30

(57) ABSTRACT

A method for wireless communication at a user equipment (UE) and related apparatus are provided. In the method, the UE transmits, for a network entity, a registration request including a first capability indication of a capability for a first encapsulation method of a data packet over a control plane, and receives, from the network entity, a registration response including a second capability indication of the capability for the first encapsulation method. The UE further communicates, based on the first capability indication and the second capability indication, the data packet over the control plane using one of the first encapsulation method or a second encapsulation method of the data packet over the control plane different from the first encapsulation method.

### CROSS REFERENCE TO RELATED APPLICATION(S)

This application claims the benefit of and priority to U.S. Provisional Application Ser. No. 63/627,748, entitled “NAS LAYER OVERHEAD REDUCTION FOR IOT NTN” and filed on Jan. 31, 2024, which is expressly incorporated by reference herein in its entirety.

### TECHNICAL FIELD

The present disclosure relates generally to communication systems and, more particularly, to overhead reduction in the non-access stratum (NAS) layer for wireless communication networks.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to transmit, for a network entity, a registration request including a first capability indication of a capability for a first encapsulation method of a data packet over a control plane; receive, from the network entity, a registration response including a second capability indication of the capability for the first encapsulation method; and communicating, based on the first capability indication and the second capability indication, the data packet over the control plane using one of the first encapsulation method or a second encapsulation method of the data packet over the control plane different from the first encapsulation method.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to receive a registration request for a UE, the registration request including a first capability indication of a capability for a first encapsulation method of a data packet over a control plane; provide a registration response for the UE, the registration response including a second capability indication of the capability for the first encapsulation method; and communicate, based on the first capability indication and the second capability indication, the data packet over the control plane using one of the first encapsulation method or a second encapsulation method of the data packet over the control plane different from the first encapsulation method.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of wireless communication including aspects of a non-terrestrial network (NTN) and a terrestrial network.

FIG. 5 is a diagram illustrating an example protocol stack in wireless communication.

FIG. 6A is a diagram illustrating an example of data encapsulation on the NAS layer for the connected mode.

FIG. 6B is a diagram illustrating an example of data encapsulation on the NAS layer for the idle mode.

FIG. 7A is a diagram illustrating an example of data encapsulation in accordance with various aspects of the present disclosure.

FIG. 7B is a diagram illustrating an example of data encapsulation in accordance with various aspects of the present disclosure.

FIG. 7C is a diagram illustrating an example of data encapsulation in accordance with various aspects of the present disclosure.

FIG. 8A is a diagram illustrating an example of data encapsulation in accordance with various aspects of the present disclosure.

FIG. 8B is a diagram illustrating an example of data encapsulation in accordance with various aspects of the present disclosure.

FIG. 9A is a diagram illustrating an example of the data encapsulation for the idle mode in accordance with various aspects of the present disclosure.

FIG. 9B is a diagram illustrating an example of a data container IE in accordance with various aspects of the present disclosure.

FIG. 10 is a call flow diagram illustrating a method of wireless communication in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a network entity in accordance with various aspects of the present disclosure.

FIG. 14 is a flowchart illustrating methods of wireless communication at a network entity in accordance with various aspects of the present disclosure.

FIG. 15 is a diagram illustrating an example of a hardware implementation for an example apparatus and/or UE.

FIG. 16 is a diagram illustrating an example of a hardware implementation for an example network entity.

### DETAILED DESCRIPTION

In wireless communication, a control plane may carry signaling traffic between the UE and the network (e.g., a base station), and a user plane may carry user data. In some aspects, a user equipment (UE) may transmit small amounts of data to a network node (e.g., such as a base station) over a control plane bearer. Using the control plane for data transmission bypasses establishment of user plane bearers, which may be beneficial for the transmission of small amounts of data, e.g., below a size threshold. The data packets can be encapsulated in a data container in a message of a control plane signaling protocol. In wireless cellular networks, such as cellular networks using 3GPP protocols, the control plane signaling protocol can be the Non-Access Stratum (NAS) protocol. Encapsulation of data in a NAS protocol message leads to substantial overhead at the NAS layer. In some examples, the overhead may be comparable to the payload size. Hence, there is a need for methods and apparatus that can reduce the overhead for the data transmitted over the control plane. As an example, the small data transmission with reduced overhead may be used for Internet-of-Thing (IoT) applications in non-terrestrial networks (NTNs), which may have limited link budgets, larger delays, and more constrained cell capacities than terrestrial networks.

Various aspects presented herein provide mechanisms for reducing overhead for data transmissions over a control plane. The aspects presented herein relate generally to wireless communication. Some aspects more specifically relate to overhead reduction in the NAS layer for wireless communication networks, including IoT applications in NTNs. In some examples, a UE transmits, for a network entity, a registration request including a first capability indication of a capability for a first encapsulation method of a data packet over a control plane and receives, from the network entity, a registration response including a second capability indication of the capability for the first encapsulation method. Based on the first capability indication and the second capability indication, the UE then communicate the data packet over the control plane using one of the first encapsulation method or a second encapsulation method of the data packet over the control plane. The second encapsulation method may be different from the first encapsulation method. In some examples, the first encapsulation method may correspond to a first protocol for communicating the data packet over the control plane (which may correspond to the first overhead type), and the second encapsulation method may correspond to a second protocol different from the first protocol for communicating the data packet over the control plane (which may correspond to the second overhead type). A first overhead (corresponding to the first overhead type) associated with the first protocol may be smaller than a second overhead (corresponding to the second overhead type) associated with the second protocol. In some examples, the UE may encapsulate the data packet using the first encapsulation method, which may have a smaller number of encapsulation layers than the second encapsulation method.

Particular aspects of the subject matter described in this disclosure can be implemented to realize one or more of the following potential advantages. In some examples, by reducing the NAS layer overhead of data transmission in connected mode and idle mode of the UE, the described techniques enable data transmissions with reduced overhead and improve the efficiency of wireless communication. The reduction in overhead for small data transmissions over a control plane may be particularly beneficial for IoT applications in NTNs, which may have limited link budgets, larger delays, and more constrained cell capacities than terrestrial networks.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

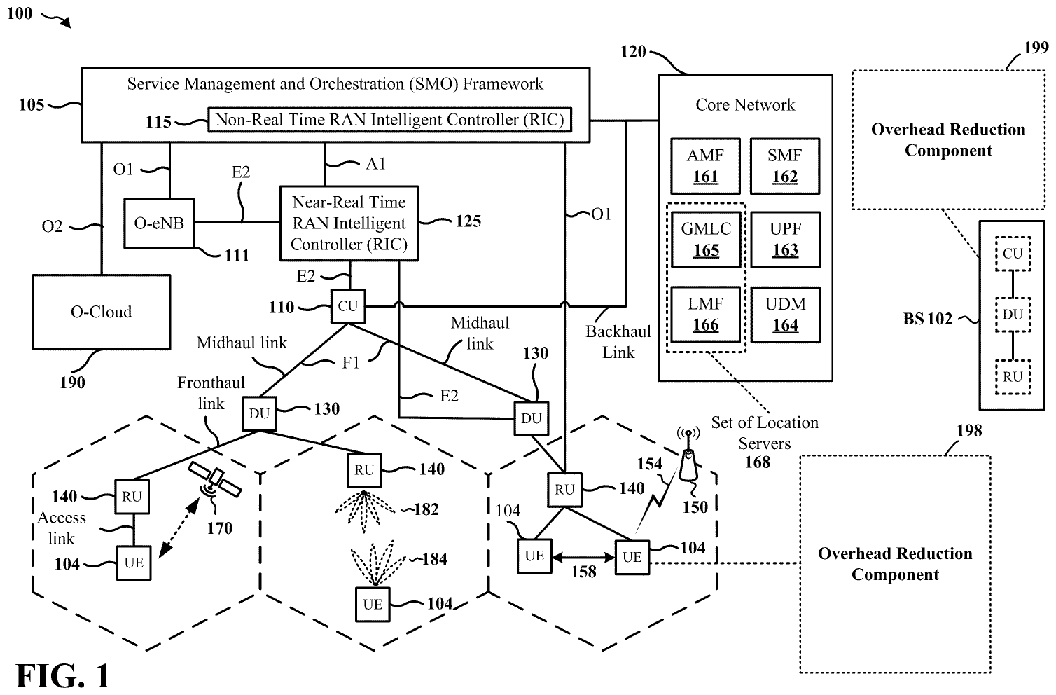

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

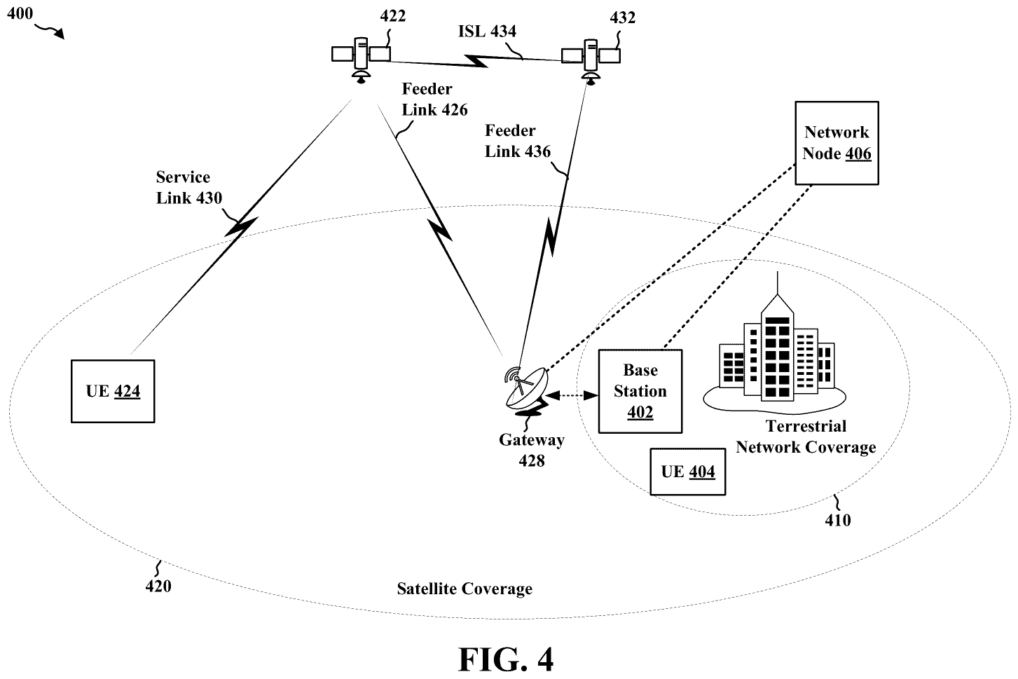

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. In some aspects, the network may include a non-terrestrial network (NTN). FIG. 1 illustrates an example in which a UE 104 may exchange wireless communication via a satellite 170, as an example of an NTN. Additional aspects of an NTN are described in further detail in connection with FIG. 4.

The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an overhead reduction component 198. The overhead reduction component 198 may be configured to transmit, for a network entity, a registration request including a first capability indication of a capability for a first encapsulation method of a data packet over a control plane; receive, from the network entity, a registration response including a second capability indication of the capability for the first encapsulation method; and communicating, based on the first capability indication and the second capability indication, the data packet over the control plane using one of the first encapsulation method or a second encapsulation method of the data packet over the control plane different from the first encapsulation method. In certain aspects, the base station 102 may include an overhead reduction component 199. The overhead reduction component 199 may be configured to receive a registration request for a UE, the registration request including a first capability indication of a capability for a first encapsulation method of a data packet over a control plane; provide a registration response for the UE, the registration response including a second capability indication of the capability for the first encapsulation method; and communicate, based on the first capability indication and the second capability indication, the data packet over the control plane using one of the first encapsulation method or a second encapsulation method of the data packet over the control plane different from the first encapsulation method. Although the following description may be focused on 5G NR, the concepts described herein may be applicable to other similar areas, such as LTE, LTE-A, CDMA, GSM, and other wireless technologies.

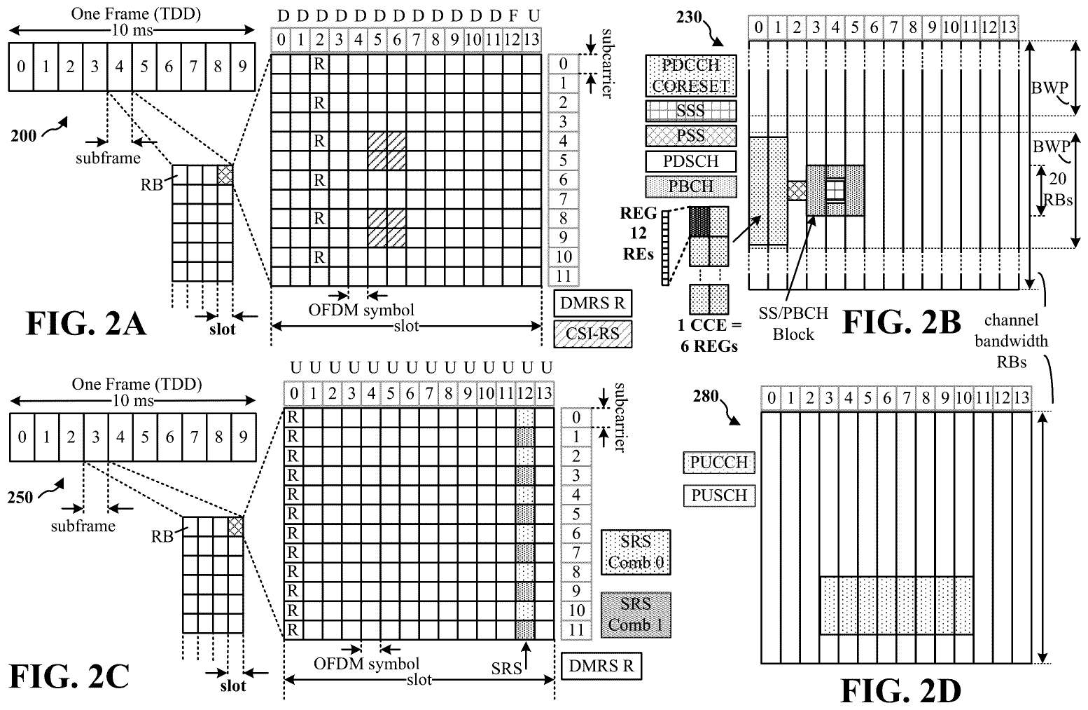

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

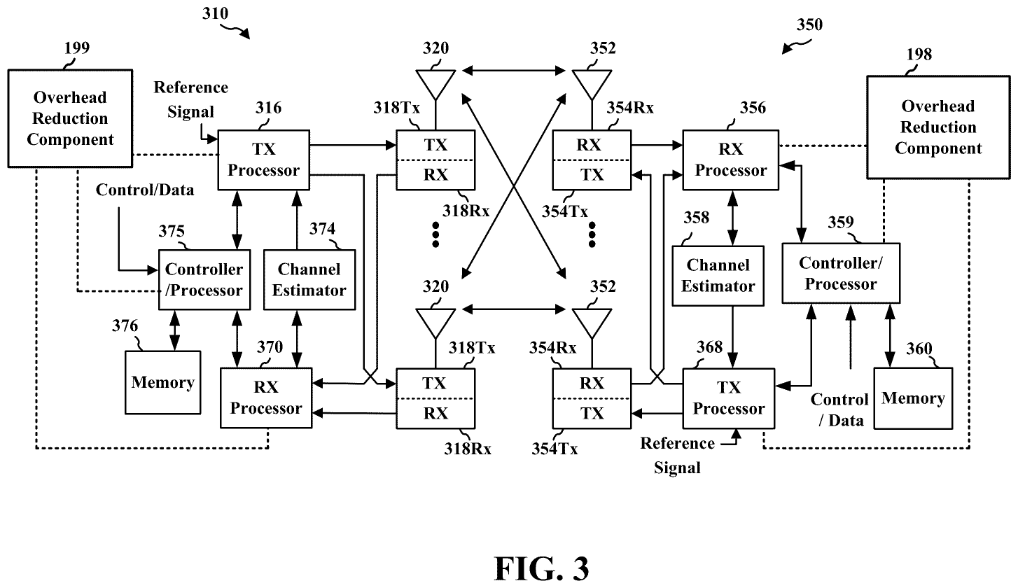

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the overhead reduction component 198 of FIG. 1.

At least one of the TX processor 316, the RX processor 370, and the controller/processor 375 may be configured to perform aspects in connection with the overhead reduction component 199 of FIG. 1.

In some examples, a UE may communicate with a terrestrial network. FIG. 4 is a diagram 400 illustrating an example of wireless communication being exchanged with a terrestrial network. In the illustrated example of FIG. 4, a terrestrial network includes a base station 402 that provides coverage to UEs, such as an example UE 404, located within a coverage area 410 for the terrestrial network. The base station 402 may facilitate communication between the UE 404 and a network node 406. Aspects of the network node 406 may be implemented by a core network, such as the example core network 120 of FIG. 1.

In some examples, a UE 424 may transmit and/or receive communication via a NTN, such as satellite-based communication. For example, a satellite 422 or other aerial device (which may also be referred to as a space vehicle (SV) or NTN node) may provide coverage to the UE 424 and other UEs, located within a coverage area 420 for the satellite 422. In some examples, the satellite 422 may communicate with the network node 406 through a feeder link 426 established between the satellite 422 and a gateway 428 in order to provide service to the UE 424 within the coverage area 420 of the satellite 422 via a service link 430. The feeder link 426 may include a wireless link between the satellite 422 and the gateway 428. The service link 430 may include a wireless link between the satellite 422 and the UE 424. In some examples, the gateway 428 may communicate directly with the network node 406. In some examples, the gateway 428 may communicate with the network node 406 via the base station 402.

In some aspects, the satellite 422 may be configured to communicate directly with the gateway 428 via the feeder link 426. The feeder link 426 may include a radio link that provides wireless communication between the satellite 422 and the gateway 428.

In other aspects, the satellite 422 may communicate with the gateway 428 via one or more other aerial devices. For example, the satellite 422 and a second satellite 432 (or second aerial device) may be part of a constellation of satellites (e.g., a set of aerial devices) that communicate via inter-satellite links (ISLs). In the example of FIG. 4, the satellite 422 may establish an ISL 434 with the second satellite 432. The ISL 434 may be a radio interface or an optical interface and operate in the RF frequency or optical bands, respectively. The second satellite 1532 may communicate with the gateway 428 via a second feeder link 436.

In some examples, the satellite 422 and/or the second satellite 432 may include an aerial device, such as an unmanned aircraft system (UAS), a balloon, a drone, an unmanned aerial vehicle (UAV), etc. Examples of a UAS platform that may be used for NTN communication include systems including Tethered UAS (TUA), Lighter Than Air UAS (LTA), Heavier Than Air UAS (HTA), and High Altitude Platforms (HAPs). In some examples, the satellite 422 and/or the second satellite 432 may include a satellite or a space-borne vehicle placed into Low-Earth Orbit (LEO), Medium-Earth Orbit (MEO), Geostationary Earth Orbit (GEO), or High Elliptical Orbit (HEO).

In some aspects, the satellite 422 and/or the second satellite 432 may implement a transparent payload. For example, after receiving a signal, a transparent NTN node may have the ability to change the frequency carrier of the signal, perform RF filtering on the signal, and amplify the signal before outputting the signal. In such aspects, the signal output by the transparent NTN node may be a repeated signal in which the waveform of the output signal is unchanged relative to the received signal.

In other aspects, the satellite 422 and/or the second satellite 432 may implement a regenerative payload. For example, a regenerative NTN node may have the ability to perform all of or part of the base station functions, such as transforming and amplifying a received signal via on-board processing before outputting a signal. In some such aspects, transformation of the received signal may refer to digital processing that may include demodulation, decoding, switching and/or routing, re-encoding, re-modulation, and/or filtering of the received signal.

In examples in which the satellite implements a transparent payload, the transparent NTN node may communicate with the base station 402 via the gateway 428. In some such examples, the base station 402 may facilitate communication between the gateway 428 and the network node 406. In examples in which the NTN node implements a regenerative payload, the regenerative NTN node may have an on-board base station. In some such examples, the on-board base station may communicate with the network node 406 via the gateway 428. In some examples, the on-board base station may include a DU and/or a CU, such as the DU 130 and the CU 110 of FIG. 1. In some examples, the on-board base station may include a DU that is in communication with a corresponding CU that is on the ground.

Example aspects presented herein provide methods and apparatus for NAS layer overhead reduction for data packets transmitted over the control plane, applicable for UE in the connected or idle modes. The methods enable more efficient wireless communication by enabling small data transmissions to be transmitted with less overhead. The aspects presented herein may be particularly beneficial for IoT applications in NTNs, which may have limited link budgets due to a distance-based signal attenuation over the large distance between the transmitter and the receiver and due to the inability of the signal transmitted to and from the satellite to penetrate indoor areas. The aspects presented herein may be particularly beneficial for IoT applications in NTNs due to larger signal propagation delays caused by the large distance between the transmitter and the receiver. The aspects presented herein may be particularly beneficial for IoT applications in NTNs due to more constrained cell capacities than terrestrial networks, which are caused by the larger size of a radio cell covered by a satellite transmitter in NTN compared to a radio cell covered by the base station in terrestrial networks. A larger radio cell comprises more users who may compete for the network resources, such as bandwidth.

Control plane (CP) cellular internet of things (CP CIoT) is a feature in wireless communication that enables a UE to transmit small amounts of data over a control plane bearer that is normally used for signaling mechanisms between the UE and the core network. For example, the UE may transmit data packets over signaling bearers between the UE and the core network that are ordinarily used for functions such as UE registrations, mobility updates, and security procedures, as opposed to dedicated user plane bearers used in conventional data transmission methods.

Transmitting data packets over the control plane allows the UE to bypass the procedure to establish user plane bearers. This procedure may be inefficient when a UE has a small amount of data (e.g., a single packet of 20 bytes) to transmit. For example, the associated signaling overhead to establish the user plane bearer may be significant in comparison to the amount of data to be transmitted.

When transmitted using CP CIoT, a data packet may be encapsulated in a data container, which may be further encapsulated in a non-access stratum (NAS) message (e.g., an evolved packet system (EPS) session management (ESM) DATA TRANSPORT message). As a result, data transfer based on CP CIoT involves overhead at the NAS layer. In some examples, up to 17 bytes of NAS layer overhead may be used for the transmission of each data packet. In some examples, the size of the overhead may be comparable to the size of the data payload, which impacts the efficiency of data transfer. The impact of the overhead is more pronounced in IoT applications in NTNs. For example, an NTN may have more limited link budgets and may experience larger delays in comparison to terrestrial wireless networks. Additionally, due to the larger cell sizes in NTNs, the capacity of each cell may be more constrained. Therefore, the aspects presented herein provide methods and apparatus that can reduce protocol overhead for small data transmissions over a control plane to improve the efficiency and performance of wireless communication, particularly for IoT applications in NTNs.

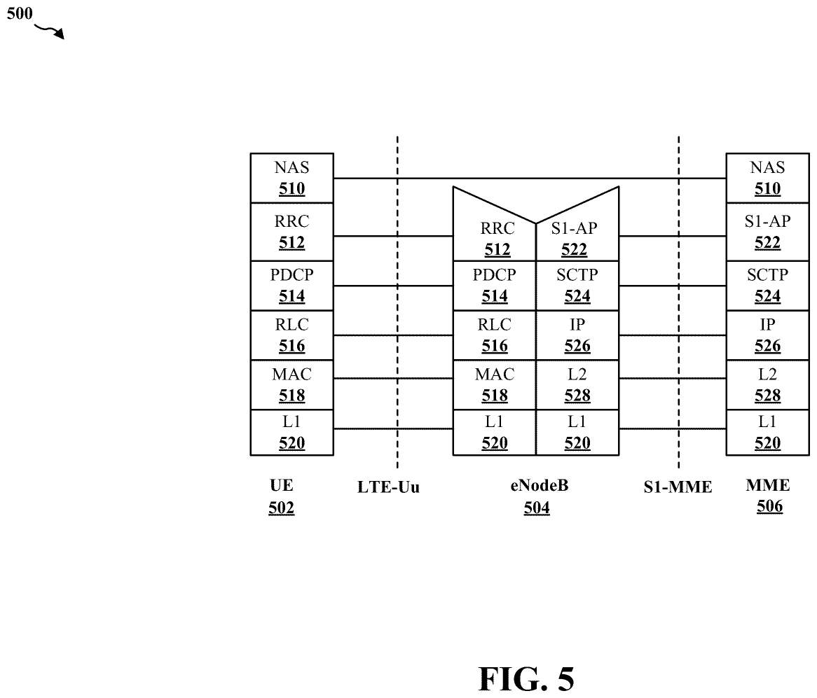

FIG. 5 is a diagram 500 illustrating an example protocol stack in wireless communication. As shown in FIG. 5, the protocol stack may include a set of protocol layers for communication over the wireless network. For example, a UE 502 and a mobility management entity (MME) 506 may communicate via a NAS layer 510. Furthermore, the UE 502 and a base station (e.g., an eNodeB 504) may communicate via various layers of the stack lower than the NAS layer 510, such as the radio resource control (RRC) layer 512, the PDCP layer 514, the RLC layer 516, the MAC layer 518, and the physical layer, such as layer 1 (L1) 520. The base station (e.g., eNodeB 504) and the MME 506 may communicate via various layers of the stack lower than the NAS layer 510, such as the S1 application protocol (S1-AP) layer 522, the stream control transmission protocol (SCTP) layer 524, the internet protocol (IP) layer 526, the data link layer (e.g., layer 2 (L2)) 528, and the physical layer (e.g., L1) 520. For NTNs, the base station (e.g., eNodeB 504) may be located in a satellite (e.g., satellite 422, 432).

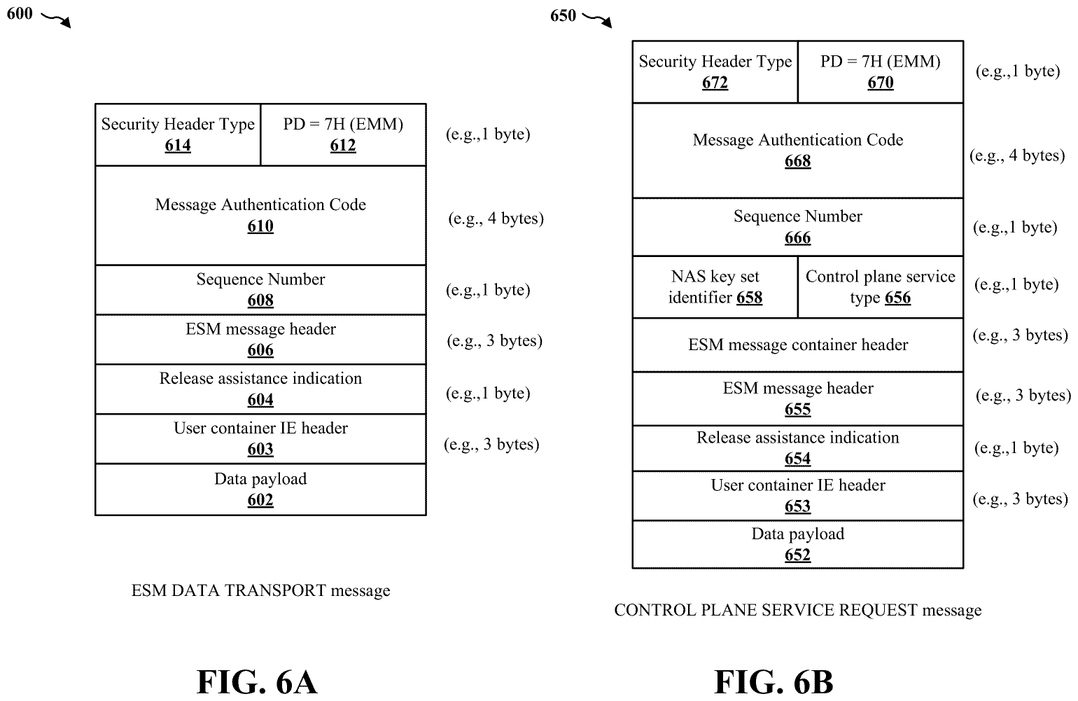

FIG. 6A is a diagram 600 illustrating an example of data encapsulation on the NAS layer for the connected mode. As shown in FIG. 6A, for a UE at the connected mode (e.g., when the UE has established an active connection with the network), the data payload 602 to be transmitted may be encapsulated within the user data container information element (IE), which may include a user container IE header 603 that may be 3 bytes. The user data container IE may be further encapsulated inside an ESM message (e.g., the ESM DATA TRANSPORT message or ESM DATA TRANSPORT NAS message). The ESM message (e.g., the ESM DATA TRANSPORT message) may be encapsulated inside a message header (e.g., a layer 3 (L3) message header, such as an ESM message header 606) and may include a protocol descriptor (PD) 612 and a security header type 614. The PD 612 may indicate the protocol associated with the message (e.g., the PD value of 7H may indicate the enhanced evolved mobility management (EMM), which is associated with the NAS protocol). An ESM message may be transmitted with security protection, which may include a 5-byte security header, for example. For example, as shown in FIG. 6A, the security header may include the message authentication code 610 (which may be 4 bytes) and a sequence number 608 (which may be 1 byte). In some examples, each of the headers in the data encapsulation structure (e.g., the user container IE header 603 and the ESM message header 606) may include a length indicator to inform the network of the length of the content associated with the header. In some examples, each length indicator may have a size of 2 bytes. Additionally, the ESM message (e.g., the ESM DATA TRANSPORT message) may include the release assistance indication 604. In some aspects, the release assistance information may be referred to with an acronym, such as RAI, or by another name. The release assistance indication 604 may inform the network whether the current packet is the last packet to be transmitted. While release assistance indication 604 is a two-bit indicator, it may occupy an entire octet (e.g., 1 byte). As a result of these layers of encapsulation and security measures, the total NAS layer overhead in the connected mode may be 13 octets (bytes) or 8 octets (bytes) if the security overhead (e.g., the message authentication code 610 and the sequence number 608) is not counted towards the overhead.

FIG. 6B is a diagram 650 illustrating an example data encapsulation on the NAS layer for the idle mode. As shown in FIG. 6B, for a UE at the idle mode (e.g., when the UE does not have an active connection with the network), the data payload 652 to be transmitted may be encapsulated within the user data container IE inside an ESM message (e.g., the ESM DATA TRANSPORT message or ESM DATA TRANSPORT NAS message), similar to the connected mode. Then, the data payload 652 may undergo an additional layer of encapsulation inside the ESM message container, which is then incorporated into a control plane message (e.g., the CONTROL PLANE SERVICE REQUEST message). The control plane message (e.g., the CONTROL PLANE SERVICE REQUEST message) may include the release assistance indication 654, which may occupy one byte. Additionally, the control plane message (e.g., the CONTROL PLANE SERVICE REQUEST message) may include a control plane service type field 656 occupying 4 bits. For example, the control plane service type field 656 may include an active flag consisting of 1 bit, and a control plane service value occupying 3 bits, which can be either mobile-originated (MO) or mobile-terminated (MT). The control plane message may further include the NAS key set identifier 658, which may occupy 4 bits. Similar to the message in the connected model, the control message may also include the PD 670 and the security header type 672. The PD 670 may indicate the protocol associated with the message (e.g., the PD value of 7H may indicate the message is associated with the NAS protocol). In some examples, each of the headers in the data encapsulation structure (e.g., the user container IE header 653 and the ESM message header 655) may include a length indicator to inform the network of the length of the content associated with the header. The ESM message header 655 may indicate an EPS bearer ID. In some examples, each length indicator may have a size of 2 bytes. As a result of these various layers of encapsulation and structural components, the total NAS layer overhead in idle mode may be 17 octets (bytes) or 12 octets (bytes) if the security overhead (e.g., the message authentication code 668 and the sequence number 666) is not counted towards the overhead.

Example aspects presented herein provide methods and apparatus to reduce the NAS layer overhead, which may be used by a UE in an RRC connected mode or an RRC idle mode. In some examples, when a data packet is transmitted over the control plane using a protocol such as the NAS protocol, the data packet may be encapsulated in a control plane message. However, this control plane message may be structured to include information (e.g., control plane service type field 656) that is not for data transmission purposes, which results in added overhead. Hence, aspects presented herein provide a new protocol for more efficient data transmission over the control plane with reduced overhead.

In some aspects, the NAS layer overhead reduction in the connected mode may involve using a field to distinguish between an idle mode message (e.g., a message from a UE in an RRC idle mode, which may include a data payload) and a connected mode message (e.g., a message sent by a UE after an RRC connection has been established with the base station), as indicated by a protocol descriptor (PD), and the removal of the control plane service type field.

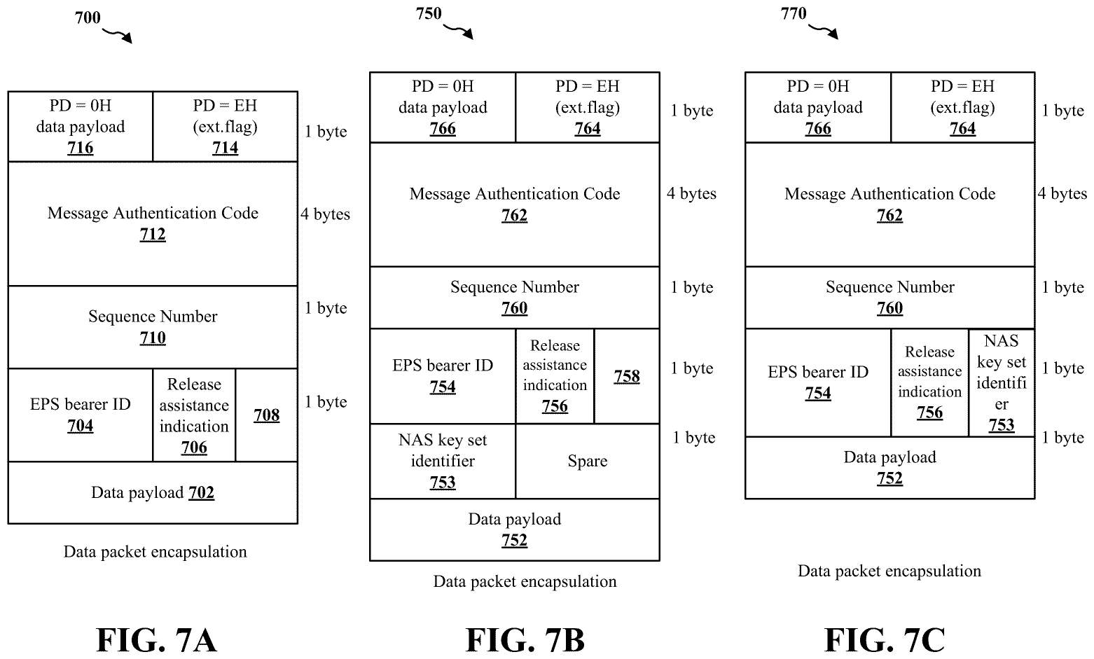

FIG. 7A is a diagram 700 illustrating an example of data encapsulation for a UE in accordance with various aspects of the present disclosure. The UE may be in, for example, an RRC connected mode. As shown in FIG. 7A, the data encapsulation structure may include an indication that a new protocol has been used for data transmission. For example, the data encapsulation structure may use the PD value of “EH” (e.g., at 714) (as an extension flag) to indicate that a new protocol has been used, and inform the receiver to use other bits to determine the protocol of the message. As shown at 716, an indication of the PD for a data payload may be included. In this example, an example PD for a data payload is indicated as “OH.” Together, the indications shown at 714 and 716 may include one byte of overhead, as an example. The data encapsulation structure may include the security overhead, such as the sequence number 710 and the message authentication code 712. In addition to protocol indication and the security overhead, the data encapsulation structure may include one byte of overhead including the EPS bearer ID 704 identifying the ID of the bearer the data payload 702 is associated with, the release assistance indication 706, and a field 708. Compared to the data encapsulation structure in FIG. 6A, the release assistance indication 706 in the example of FIG. 7A may occupy a reduced set of bits, such as 2 bits instead of an entire octet (byte). The control plane service type field may be removed in the data encapsulation structure in FIG. 7A, as the control plane data transfer may be categorized as mobile originated (MO) and may not use the “Active” flag. Additionally, the encapsulation of the L3 message in the RRC messages remains unchanged. The encapsulation method in FIG. 7A would result in a total overhead of 7 octets (bytes) or 2 octets (bytes) if the security overhead (e.g., the sequence number 710 and the message authentication code 712) is not counted towards the overhead, representing a reduction of 6 octets of encapsulation overhead (compared to the data encapsulation structure in FIG. 6A). The example message shown in FIG. 7A may be used by a UE to send a message to a network entity such as a mobile management entity (MME). In some examples, the total overhead for the encapsulation method in FIG. 7A may be associated with the first overhead type (e.g., for connected mode), and the total overhead for the encapsulation structure in FIG. 6A may be associated with the second overhead type (e.g., for connected mode).

FIG. 7B is a diagram 750 illustrating an example of data encapsulation in accordance with various aspects of the present disclosure. The data encapsulation structure may be applicable for UE in, for example, the idle mode. As shown in FIG. 7B, the data encapsulation structure may include PD 764, and indication at 766, which may indicate that a new protocol has been used for data transmission, similar to 714 and 716. The data encapsulation structure may further include the security overhead, such as the sequence number 760 and the message authentication code 762, one byte of overhead including the EPS bearer ID 754 identifying the ID of the bearer the data payload 752 is associated with, the release assistance indication 756, and a field 758, e.g., as described in connection with 704, 706, 708, 710, and 712 of FIG. 7A. The data encapsulation structure may further include a NAS key set identifier 753 for the data transmission, which may leave a spare amount of one byte for additional information. As an example, 1/2 of the byte may remain as spare. Compared to the data encapsulation structure in FIG. 6B, the release assistance indication 756 in the example of FIG. 7B may occupy 2 bits instead of an entire octet (byte), and the control plane service type field 656 in FIG. 6B may be removed from the data encapsulation structure in FIG. 7B, as the control plane data transfer may be categorized as mobile originated (MO) and may not have the “Active” flag. As shown in FIG. 7B, the total overhead may be 8 octets (bytes) or 3 octets (bytes) if the security overhead (e.g., the sequence number 760 and the message authentication code 762) is not counted towards the overhead, representing a reduction of 9 octets of encapsulation overhead (compared to the data encapsulation structure in FIG. 6B). In some examples, the total overhead for the encapsulation method in FIG. 7B may be associated with the first overhead type (for idle mode), and the total overhead for the encapsulation structure in FIG. 6B may be associated with the second overhead type (for idle mode).

FIG. 7C is a diagram 770 illustrating an example of data encapsulation in accordance with various aspects of the present disclosure. As shown in FIG. 7C, the data encapsulation structure may include PD 764, and indication at 766 as shown in FIG. 7B. The data encapsulation structure may further include the security overhead, such as the sequence number 760 and the message authentication code 762, one byte of overhead including the EPS bearer ID 754 identifying the ID of the bearer the data payload 752 is associated with, the release assistance indication 756, and a NAS key set identifier 753, for example.

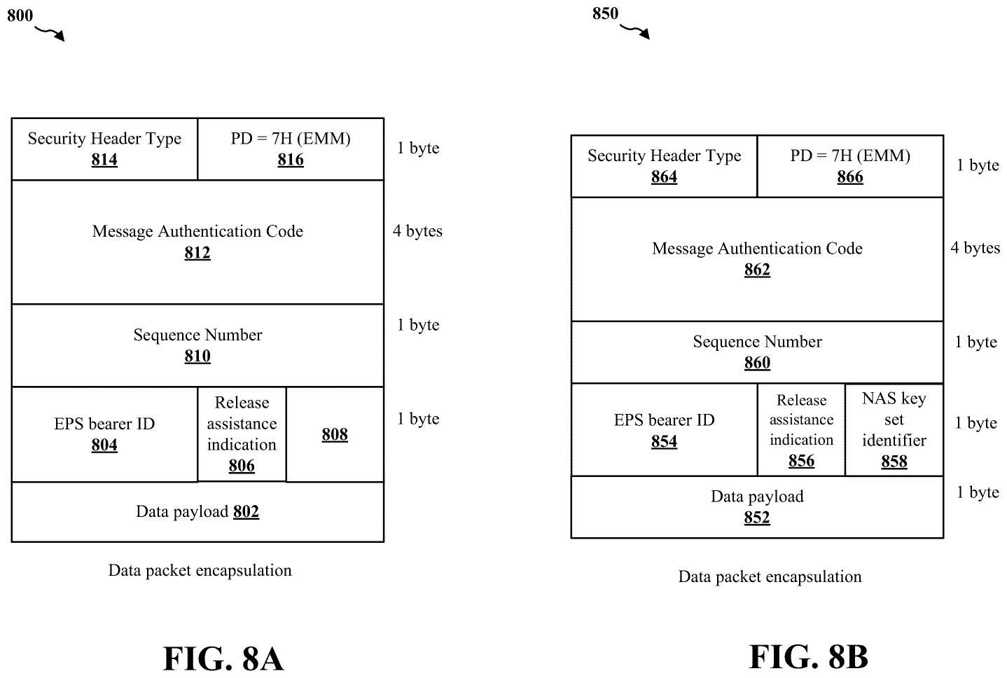

FIG. 8A is a diagram 800 illustrating an example of data encapsulation for a UE in accordance with various aspects of the present disclosure. The UE may be in, for example, an RRC connected mode. As shown in FIG. 8A, the data encapsulation structure may include a security header type 814 and a PD 816, similar to security header type 614 and PD 612, respectively. As an example, the PD 816 may have a value of “7H.” The data encapsulation structure may include the security overhead, such as the sequence number 810 and the message authentication code 812. In some examples, the data encapsulation structure may include one byte of overhead including the EPS bearer ID 804 identifying the ID of the bearer the data payload 802 is associated with, the release assistance indication 806, and a field 808. Compared to the data encapsulation structure in FIG. 6A, the release assistance indication 806 in the example of FIG. 8A may occupy a reduced set of bits, such as 2 bits instead of an entire octet (byte). The example message shown in FIG. 8A may be used by a UE to send a message to a network entity such as a mobile management entity (MME). In some examples, the total overhead for the encapsulation method in FIG. 8A may be associated with the first overhead type (e.g., for connected mode), and the total overhead for the encapsulation structure in FIG. 6A may be associated with the second overhead type (e.g., for connected mode).

FIG. 8B is a diagram 850 illustrating an example of data encapsulation in accordance with various aspects of the present disclosure. The data encapsulation structure may be applicable for UE in, for example, the idle mode. As shown in FIG. 8B, the data encapsulation structure may include security header type 864, and PD 866, similar to security header type 672 and PD 670, respectively. The data encapsulation structure may further include the security overhead, such as the sequence number 860 and the message authentication code 862, one byte of overhead including the EPS bearer ID 854 identifying the ID of the bearer the data payload 852 is associated with, the release assistance indication 856, e.g., as described in connection with 702, 704, 706, 710, and 712 of FIG. 7A. The data encapsulation structure may further include a NAS key set identifier 858 for the data transmission. Compared to the data encapsulation structure in FIG. 6B, the release assistance indication 856 in the example of FIG. 8B may occupy 2 bits instead of an entire octet (byte), and the control plane service type field 656 in FIG. 6B may be removed from the data encapsulation structure in FIG. 8B.

In some aspects, the method for reducing NAS layer overhead may involve the removal of the length indicator from the overhead (e.g., the length indicator in the user container IE header 603, 653 and the ESM message header 606, 655). In some examples, the MME may deduce the size of an L3 message based on the length indication in the NAS-protocol data unit (NAS-PDU) IE at the S1-AP layer (e.g., 522). This approach for determining the message size may be applicable to NAS messages.

Based on the size of the L3 message as determined by the MME, the size of the data payload (e.g., data payload 702, 752, 802, 852) may be deduced. This inference may effectively remove the necessity to provide a separate length indicator (e.g., the length indicator in the user container IE header 603, 653 and the ESM message header 606, 655) alongside the data payload (e.g., data payload 702, 752, 802, 852).

In some aspects, to facilitate the overhead reduction in the NAS layer (e.g., for IoT applications in NTNs or for other applications), the UE and the network may exchange capability information to indicate support for the new NAS layer exchange mechanisms or new protocol (e.g., such as described in connection with any of FIG. 7A, FIG. 7B, FIG. 7C, FIG. 8A, and FIG. 8B, and which may be referred to as a reduced overhead protocol). For example, the UE may indicate its support for the new protocol to the network. The UE may transmit the indication in messages such as an attach request or a tracking area update request message. Following the UE's indication, the network (e.g., a base station) may indicate its support for the new protocol back to the UE. The network's indication may be included in messages such as an attach response or a tracking area update response message.

If UE indicates support for the new protocol, and the network indicates its support for the new protocol, the UE may then utilize this new protocol (e.g., corresponding to the first overhead type) for data transmission over the control plane. For example, the UE may use the data encapsulation structure shown in FIG. 7A or 8A (e.g., for connected mode) or FIG. 7B, 7C, or 8B (e.g., for idle mode) for data transmission over the control plane. On the other hand, if the network does not indicate support for the new protocol, the UE may revert to sending data in a NAS message using a different protocol (e.g., a NAS protocol having a higher overhead such as described in connection with FIG. 6A or 6B). For example, the UE may use the data encapsulation structure shown in FIG. 6A (e.g., for connected mode) and FIG. 6B (e.g., for idle mode) for data transmission over the control plane.

The MME may adapt to support a new L3 message header. For example, the MME may be configured to recognize and process the payload of the L3 message with a PD of OH (e.g., in PD 716, 766) as if it were the payload of a user data container encapsulated inside the ESM DATA TRANSPORT or CONTROL PLANE SERVICE REQUEST (CPSR) message.

Additionally, to support the methods to reduce the NAS layer overhead, a new support indication mechanism may be provided. In some examples, the new message format in idle mode may be configured to support additional IE formats in the CPSR message, such as EPS bearer context status and IEs specific to multi-subscriber identity module (MUSIM) UEs.

In some aspects, example aspects presented herein introduce a new L3 protocol specifically for data transfer over the control plane (e.g., for IoT applications in NTNs). This protocol may include distinct messages for idle and connected modes. Based on this protocol, the data payload (e.g., data payload 702, 752, 802, 852) may be encapsulated directly under the L3 message header, resulting in significant reductions in overhead. In some examples, this new encapsulation method may remove 9 octets of overhead in idle mode and 6 octets in connected mode.

The methods to reduce the NAS layer overhead may enable the UE and the network to exchange data messages over the control plane with reduced overhead through changes at the UE and the MME, e.g., without changing the protocol layers other than the NAS layer. Additionally, this new protocol can be used without affecting other protocol layers, through modifications within the NAS layer. In some aspects, the network protocol may be used by the UE and network (e.g., or may be supported by the UE/network) based on certain applications. As an example, for applications where overhead size is less important, other data transfer mechanisms over the NAS layer (e.g., with the data encapsulation structures shown in FIG. 6A or FIG. 6B) may be used.

When transmitting the data payload using the aspects presented herein, the UE and MME's logic for processing new messages may remain consistent with other NAS procedures, with the message syntax changed. For example, one new message may correspond to a CPSR message, while another new message may correspond to the ESM DATA TRANSPORT message. To facilitate the implementation of this new protocol, an exchange of support indications between the network and UE may be used to help ensure compatibility and efficient operation, such as in IoT NTN environments.

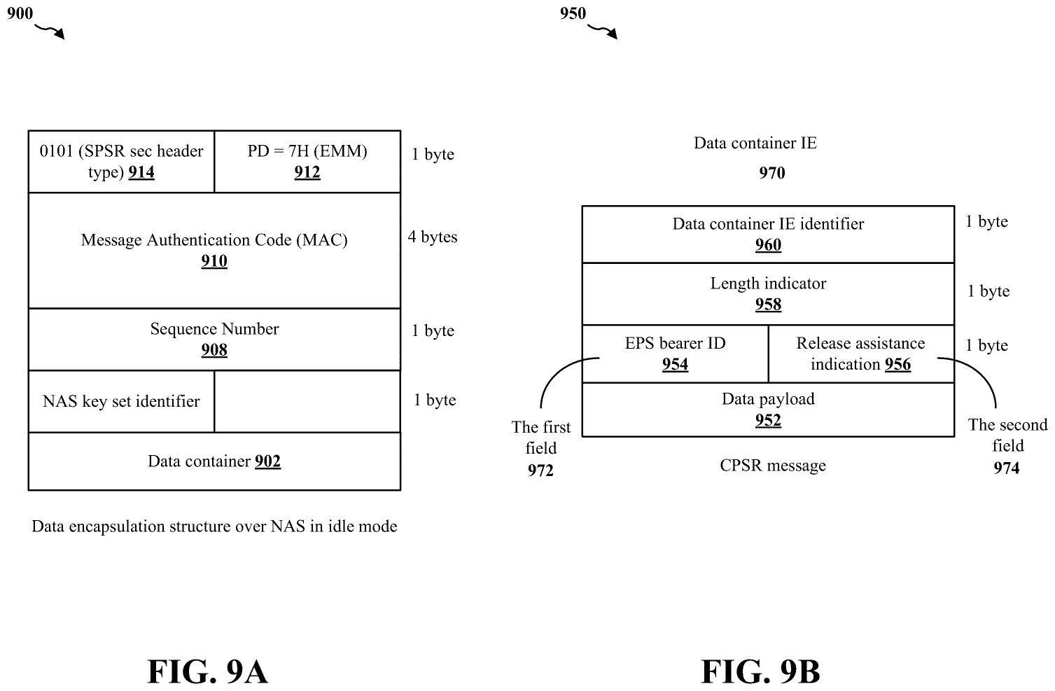

In some aspects, the overhead reduction for the NAS layer (e.g., in IoT applications in NTNs) may be implemented via an optimized NAS encapsulation method for the data payload, e.g., based on the NAS protocol for data transmission. FIG. 9A is a diagram 900 illustrating an example of the data encapsulation for the idle mode (e.g., a message transmitted by a UE in an RRC idle mode) in accordance with various aspects of the present disclosure. FIG. 9B is a diagram 950 illustrating an example of a data container IE 970 in accordance with various aspects of the present disclosure. As shown in FIG. 9A and FIG. 9B, the data payload 952 may be encapsulated or contained within a data container IE (e.g., data container IE 970) inside a CPSR message. In some examples, this data container IE 970 (e.g., data container 902) may include an overhead of one byte over the data payload 952, which may carry information such as the EPS bearer ID 954 and the release assistance indication 956. In some examples, this data container IE 970 may include a first field 972 for the EPS bearer ID 954 and a second field 974 for the release assistance indication 956. Additionally, the data container IE 970 may have its identifier, such as the data container IE identifier 960 and a length indicator 958.

As shown in FIG. 9A, in some examples, the example of the data encapsulation may include a PD 912 and a security header type 914. As shown in FIG. 9A, the total NAS layer overhead in idle mode may be reduced to 10 bytes or 5 bytes if the security overhead (e.g., the sequence number 908 and the message authentication code 910) is not counted toward the overhead.

In some examples, to support the encapsulation mechanism described above, the support indications may inform the network of the new IE (e.g., the data container 902) utilized.

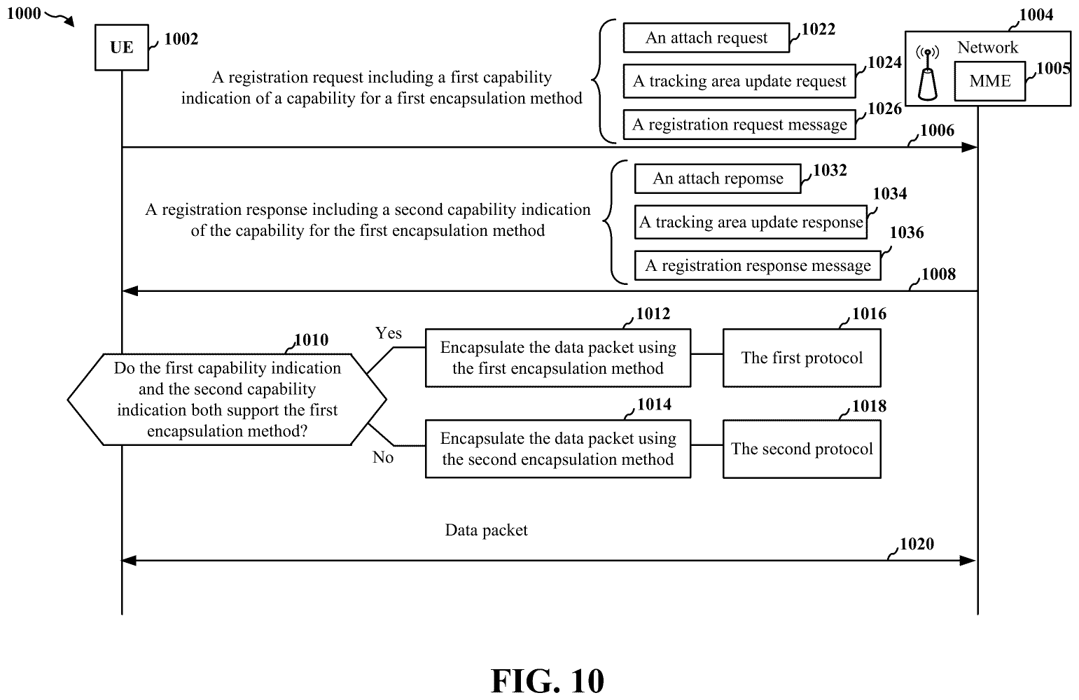

FIG. 10 is a call flow diagram 1000 illustrating a method of wireless communication in accordance with various aspects of this present disclosure. Various aspects are described in connection with a UE 1002 and a network 1004 (e.g., which may include a network node such as a base station). The aspects may be performed by the UE 1002 or the network 1004 (e.g., by a base station in aggregation and/or by one or more components of a base station (e.g., a CU 110, a DU 130, and/or an RU 140). For NTNs, the network 1004 (which may include a base station, such as the base station 102, 310, or eNodeB 504, for example) may be located in a satellite (e.g., satellite 422, 432). In the example illustrated in FIG. 10, the transmission (e.g., over-the-air (OTA) transmission) may be between the UE 1002 and the network 1004 (which may include a base station). The NAS messages exchanged between the UE 1002 and the network 1004 (e.g., the MME 1005) may be encapsulated inside the RRC messages sent OTA. The network 1004 may forward the NAS messages received OTA from the UE (e.g., UE 424, 502, 1002) to the MME (e.g., MME 506, 1005) using S1-AP protocol (e.g., 522).

As shown in FIG. 10, at 1006, a UE 1002 may transmit a registration request or other message that includes a first capability indication of a capability for a first encapsulation method for transmission of a data packet over a control plane (e.g., an encapsulation that has a reduced overhead such as described in connection with any of FIGS. 7A, FIG. 7B, FIG. 7C, FIG. 8A, FIG. 8B, FIG. 9A, or FIG. 9B). For example, the first encapsulation method may have a reduced overhead (e.g., the first overhead type) for data transmission over the control plane than a second encapsulation method for data transmission over the control plane. For example, the first capability indication may indicate whether the UE 1002 has the capability to support the first encapsulation method. The first encapsulation method may be the method to encapsulate a data payload (e.g., 702, 752, 802, 852) based on the encapsulation structure shown in FIG. 7A, FIG. 7B, FIG. 7C, FIG. 8A, and FIG. 8B. In some examples, the registration request may include one of an attach request (e.g., 1022), a tracking area update request (e.g., 1024), or a registration request message (e.g., 1026).

At 1008, the UE 1002 may receive, from the network 1004, a registration response or other transmission, that includes a second capability indication indicating that the network supports the first encapsulation method. For example, the second capability indication may indicate whether the network (e.g., MME 1005) supports the capability for the first encapsulation method. In some examples, the registration response may include one of: an attach response (e.g., 1032), a tracking area update response (e.g., 1034), or a registration response message (e.g., 1036).

Then, depending on whether the first capability indication and the second capability indication both indicate support for the first encapsulation method (at 1010), the UE 1002 may, at 1012, encapsulate the data packet using the first encapsulation method (when both the first and second capability indications support the first encapsulation method) or, at 1014, encapsulate the data packet using the second encapsulation method (when at least one of the first and second capability indications does not support the first encapsulation method). For example, when both the UE 1002 and the network 1004 support the first encapsulation method, the UE 1002 may encapsulate the data packet (e.g., data payload 702, 752, 802, 852) using the first encapsulation method (e.g., using the encapsulation structure in FIG. 7A, FIG. 7B, FIG. 7C, FIG. 8A, or FIG. 8B). Otherwise, if one of the UE 1002 or the network 1004 does not support the first encapsulation method, the UE 1002 may encapsulate the data packet (e.g., data payload 602, 652) using the second encapsulation method for transmission over the control plane (e.g., using the encapsulation structure in FIG. 6A (e.g., for connected mode) or FIG. 6B (e.g., for idle mode)).

In some examples, at 1016, the first encapsulation method may be associated with the first overhead type, e.g., which may correspond to a first protocol for communicating the data packet over the control plane, and, at 1018, the second encapsulation method may be associated with the second overhead type, e.g., which may correspond to a second protocol different from the first protocol for communicating the data packet over the control plane. A first overhead associated with the first protocol may be smaller than a second overhead associated with the second protocol. For example, as shown in FIG. 7A and FIG. 7B, the first overhead may be 2 octets (bytes) for connected mode and 3 octets (bytes) for idle mode (not counting the security overhead). As shown in FIG. 6A and FIG. 6B, the second overhead may be 8 octets (bytes) for connected mode and 12 octets (bytes) for idle mode (not counting the security overhead). The first overhead may be smaller than the second overhead.

At 1020, the UE 1002 may, at 1020, communicate, based on the first capability indication and the second capability indication, the data packet over the control plane using one of the first encapsulation method (e.g., at 1012) or a second encapsulation method (e.g., at 1014) of the data packet over the control plane different from the first encapsulation method. For example, the UE 1002 may transmit an uplink data packet or receive a downlink data packet (e.g., data payload 602, 652, 702, 752, 802, 852) using the first encapsulation method (e.g., the encapsulation structure in FIG. 7A, FIG. 7B, FIG. 7C, FIG. 8A, or FIG. 8B) or the second encapsulation method (e.g., the encapsulation structure in FIG. 6A (e.g., for connected mode) or FIG. 6B (e.g., for idle mode)).

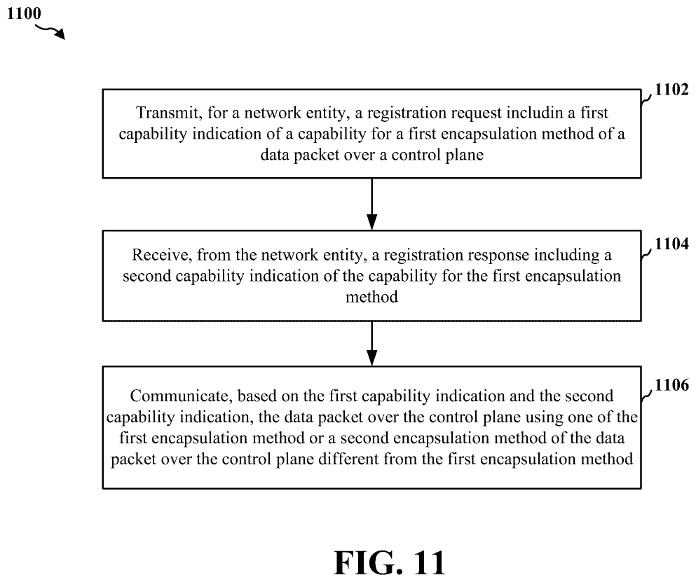

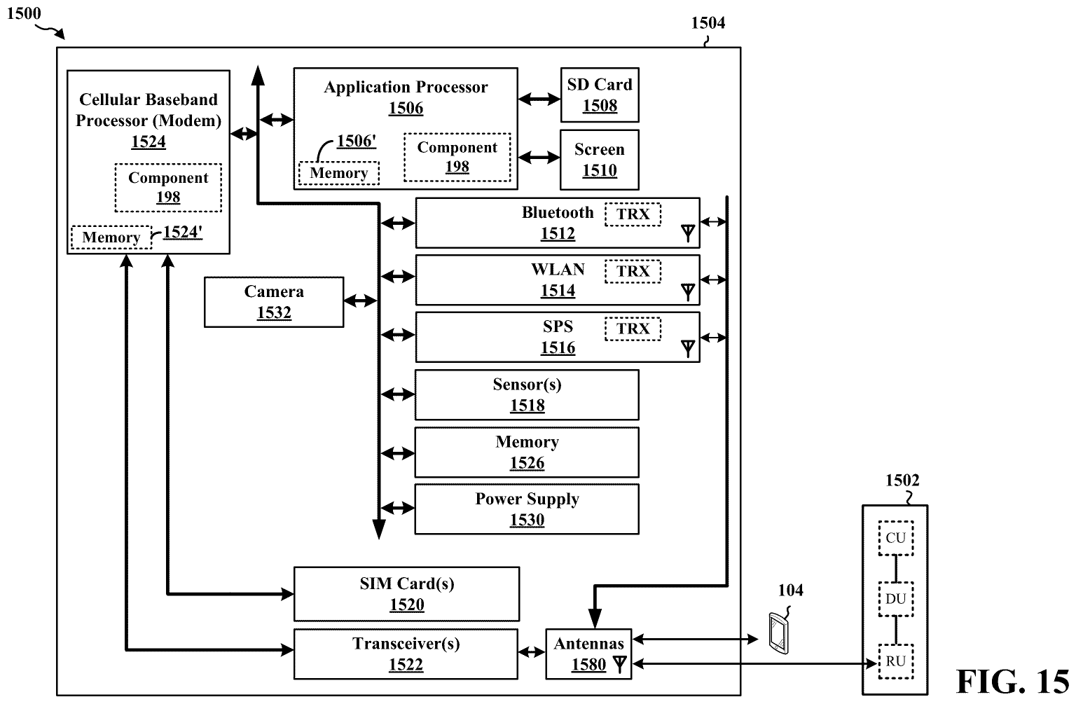

FIG. 11 is a flowchart 1100 illustrating methods of wireless communication at a UE in accordance with various aspects of the present disclosure. The method may be performed by a UE. The UE may be the UE 104, 350, 1002, or the apparatus 1504 in the hardware implementation of FIG. 15. The methods significantly reduce the NAS layer overhead of data transmission in connected mode and idle mode of the UE. The methods improve the efficiency of wireless communication. They are particularly beneficial for IoT applications in NTNs, which have limited link budgets, larger delays, and more constrained cell capacities than terrestrial networks.

As shown in FIG. 11, at 1102, the UE may transmit, for a network entity, a registration request including a first capability indication of a capability for a first encapsulation method of a data packet over a control plane. The network entity may be a base station, or a component of a base station, in the access network of FIG. 1 or a core network component (e.g., base station 102, 310; network 1004; or the network entity 1502 in the hardware implementation of FIG. 15). FIG. 7A, FIG. 7B, FIG. 7C, FIG. 8A, FIG. 8B, FIG. 9A, FIG. 9B, and FIG. 10 illustrate various aspects of the steps in connection with flowchart 1100. For example, referring to FIG. 10, the UE 1002 may transmit, at 1006, for a network entity (e.g., network 1004 via a base station), a registration request including a first capability indication of a capability for a first encapsulation method of a data packet over a control plane. In some examples, 1102 may be performed by the overhead reduction component 198.

At 1104, the UE may receive, from the network entity, a registration response including a second capability indication of the capability for the first encapsulation method. For example, referring to FIG. 10, the UE 1002 may receive, at 1008, from the network entity (network 1004), a registration response including a second capability indication of the capability for the first encapsulation method. In some examples, 1104 may be performed by the overhead reduction component 198.

At 1106, the UE may communicate, based on the first capability indication and the second capability indication, the data packet over the control plane using one of the first encapsulation method or a second encapsulation method of the data packet over the control plane. The second encapsulation method may be different from the first encapsulation method. For example, referring to FIG. 10, the UE 1002 may communicate the data packet over the control plane using one of the first encapsulation method or the second encapsulation method with the network 1004. For example, when both the UE 1002 and the network 1004 support the first encapsulation method, the UE 1002 may encapsulate the data packet (e.g., data payload 702, 752, 802, 852) using the first encapsulation method (e.g., using the encapsulation structure in FIG. 7A, FIG. 7B, FIG. 7C, FIG. 8A, or FIG. 8B). Otherwise, if one of the UE 1002 or network 1004 does not support the first encapsulation method, the UE 1002 may encapsulate the data packet (e.g., data payload 602, 652) using the second encapsulation method (e.g., using the encapsulation structure in FIG. 6A (e.g., for connected mode) or FIG. 6B (e.g., for idle mode)). In some examples, 1106 may be performed by the overhead reduction component 198.

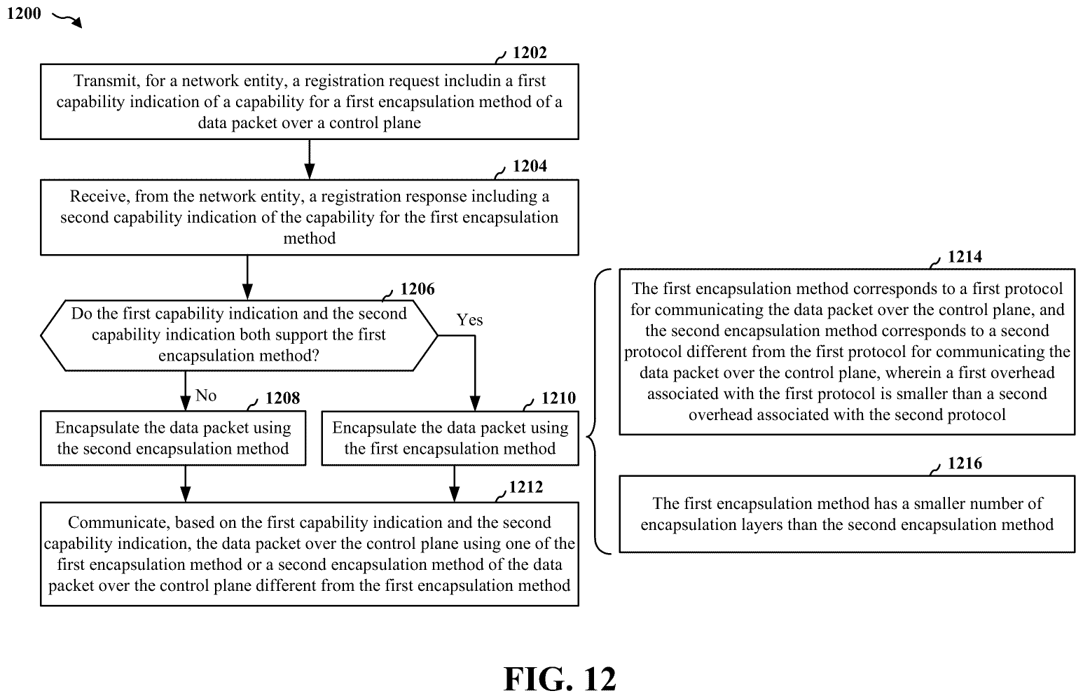

FIG. 12 is a flowchart 1200 illustrating methods of wireless communication at a UE in accordance with various aspects of the present disclosure. The method may be performed by a UE. The UE may be the UE 104, 350, 1002, or the apparatus 1504 in the hardware implementation of FIG. 15. The methods significantly reduce the NAS layer overhead for data transmission in connected mode and idle mode of the UE. The methods improve the efficiency of wireless communication. They are particularly beneficial for IoT applications in the NTN, which has limited link budgets, cell capacities, and larger delays than terrestrial networks.

As shown in FIG. 12, at 1202, the UE may transmit, for a network entity, a registration request including a first capability indication of a capability for a first encapsulation method of a data packet over a control plane. The network entity may be a base station, or a component of a base station, in the access network of FIG. 1 or a core network component (e.g., base station 102, 310; network 1004; or the network entity 1502 in the hardware implementation of FIG. 15). FIG. 7A, FIG. 7B, FIG. 7C, FIG. 8A, FIG. 8B, FIG. 9A, FIG. 9B, and FIG. 10 illustrate various aspects of the steps in connection with flowchart 1200. For example, referring to FIG. 10, the UE 1002 may transmit, at 1006, for a network entity (network 1004), a registration request including a first capability indication of a capability for a first encapsulation method of a data packet over a control plane. In some examples, 1202 may be performed by the overhead reduction component 198.

At 1204, the UE may receive, from the network entity, a registration response including a second capability indication of the capability for the first encapsulation method. For example, referring to FIG. 10, the UE 1002 may receive, at 1008, from the network entity (network 1004), a registration response including a second capability indication of the capability for the first encapsulation method. In some examples, 1204 may be performed by the overhead reduction component 198.

At 1212, the UE may communicate, based on the first capability indication and the second capability indication, the data packet over the control plane using one of the first encapsulation method or a second encapsulation method of the data packet over the control plane. The second encapsulation method may be different from the first encapsulation method. For example, referring to FIG. 10, the UE 1002 may communicate the data packet over the control plane using one of the first encapsulation method or the second encapsulation method with the network 1004. For example, when both the UE 1002 and the network 1004 support the first encapsulation method, the UE 1002 may encapsulate the data packet (e.g., data payload 702, 752, 802, 852) using the first encapsulation method (e.g., using the encapsulation structure in FIG. 7A, FIG. 7B, FIG. 7C, FIG. 8A, or FIG. 8B). Otherwise, if one of the UE 1002 or network 1004 does not support the first encapsulation method, the UE 1002 may encapsulate the data packet (e.g., data payload 602, 652) using the second encapsulation method (e.g., using the encapsulation structure in FIG. 6A (e.g., for connected mode) or FIG. 6B (e.g., for idle mode)). In some examples, 1212 may be performed by the overhead reduction component 198.

In some aspects, to communicate the data packet (at 1212), the UE may transmit or receive the data packet using the one of the first encapsulation method or the second encapsulation method. For example, referring to FIG. 10, the UE 1002 may, at 1020, transmit or receive the data packet using the one of the first encapsulation method or the second encapsulation method.

In some aspects, the registration request may include one of: an attach request, a tracking area update request, or a registration request message. For example, referring to FIG. 10, the registration request (at 1006) may include one of: an attach request 1022, a tracking area update request 1024, or a registration request message 1026.

In some aspects, the registration response may include one of: an attach response, a tracking area update response, or a registration response message. For example, referring to FIG. 10, the registration response (at 1008) may include one of: an attach response 1032, a tracking area update response 1034, or a registration response message 1036.

In some aspects, at 1206, the UE may determine whether the first capability indication and the second capability indication both support the first encapsulation method. At 1208, if at least one of the first capability indication and the second capability indication does not support the first encapsulation method, the UE may encapsulate the data packet using the second encapsulation method. At 1210, if the first capability indication and the second capability indication both support the first encapsulation method, the UE may encapsulate the data packet using the first encapsulation method. For example, referring to FIG. 10, the UE 1002 may, at 1010, determine whether the first capability indication and the second capability indication both support the first encapsulation method. Referring to FIG. 7A and FIG. 7B, when both the first capability indication and the second capability indication support the first encapsulation method, the UE may encapsulate the data packet (e.g., data payload 702, 752, 802, 852) using the first encapsulation method (e.g., using the encapsulation structure in FIG. 7A, FIG. 7B, FIG. 7C, FIG. 8A, or FIG. 8B). In some aspects, 1208 and 1210 may be performed by the overhead reduction component 198.

In some aspects, at 1214, the first encapsulation method may correspond to a first protocol for communicating the data packet over the control plane, and the second encapsulation method may correspond to a second protocol different from the first protocol for communicating the data packet over the control plane. The first overhead associated with the first protocol may be smaller than the second overhead associated with the second protocol. For example, referring to FIG. 7A and FIG. 7B, the first overhead may be associated with the first protocol, and the second overhead may be associated with the second protocol. For example, the first overhead may be 2 octets (bytes) for connected mode and 3 octets (bytes) for idle mode (not counting the security overhead). As shown in FIG. 6A and FIG. 6B, the second overhead may be 8 octets (bytes) for connected mode and 12 octets (bytes) for idle mode (not counting the security overhead). The first overhead may be smaller than the second overhead.

In some aspects, each of the first protocol and the second protocol may be a signaling protocol. For example, referring to FIG. 10, each of the first protocol (associated with the first encapsulation method at 1012) and the second protocol (associated with the second encapsulation method at 1014) may be a signaling protocol.

In some aspects, the second protocol may be a NAS protocol. For example, referring to FIG. 10, the second protocol (associated with the second encapsulation method at 1014) may be a NAS protocol.

In some aspects, each of the first protocol and the second protocol may be carried over a signaling radio bearer. For example, referring to FIG. 10, each of the first protocol (associated with the first encapsulation method at 1012) and the second protocol (associated with the second encapsulation method at 1014) may be carried over a signaling radio bearer.

In some aspects, the first overhead may not include an indication of the length of the data packet, and the second overhead may include the indication of the length of the data packet. For example, referring to FIG. 7A, the first overhead (including PD 714, PD 716, EPS bearer ID 704, release assistance indication 706, and the field 708) may not include an indication of the length of the data packet (e.g., data payload 702). On the other hand, referring to FIG. 6A, the second overhead may include the indication of the length of the data packet (e.g., in the user container IE header 603, the ESM message header 606).

In some aspects, the UE may encapsulate the data packet using the first encapsulation method (at 1210), and the first overhead may include a protocol descriptor (PD) indicating the first protocol. For example, referring to FIG. 10, the UE 1002 may, at 1012, encapsulate the data packet using the first encapsulation method. Referring to FIG. 7A, the first overhead may include a PD (e.g., PD 714) indicating the first protocol. In some examples, the PD may indicate that the payload carries a data packet, e.g., without encapsulation overhead

In some aspects, the first overhead may include a release assistance indication field, and the size of the release assistance indication field is less than one byte. For example, referring to FIG. 7A, the first overhead may include release assistance indication 706, and the size of the release assistance indication 706 may be less than one byte.

In some aspects, the size of the release assistance indication field may be two bits. For example, referring to FIG. 7A, FIG. 7B, FIG. 7C, the size of the release assistance indication (e.g., 706, 756) may be two bits.

In some aspects, the first overhead may include a field indicating one of an idle mode or a connected mode for transmitting the data packet.

In some aspects, the UE may encapsulate the data packet using the first encapsulation method (at 1210), and, at 1216, the first encapsulation method may have a smaller number of encapsulation layers than the second encapsulation method (at 1208). For example, FIG. 6B shows an example of the second encapsulation method, which includes multiple layers of encapsulation (e.g., via user container IE header 653, ESM message header 655). On the other hand, FIG. 9A shows an example of the first encapsulation method, which may have a smaller number of encapsulation layers than the second encapsulation method (e.g., the first encapsulation method shown in FIG. 9A does not have user container IE header 653 or ESM message header 655 in FIG. 6B).

In some aspects, to encapsulate the data packet using the first encapsulation method (at 1210), the UE may encapsulate the data packet in a data container information element (IE). For example, referring to FIG. 9A, the UE may encapsulate the data packet in a data container IE (e.g., data container 902). In some aspects, the data container IE may have one byte of overhead carrying an evolved packet system (EPS) bearer identifier (ID) and the release assistance indication field. For example, referring to FIG. 9B, the data container IE 970 may have one byte of overhead carrying an EPS bearer ID 954 and the release assistance indication 956.

In some aspects, the data container IE may have a first field for an evolved packet system (EPS) bearer identifier (ID) and a second field for the release assistance indication. For example, referring to FIG. 9B, the data container IE 970 may have the first field 972 for the EPS bearer ID 954 and the second field 974 for release assistance indication 956.

In some aspects, the data container IE may include an identifier and a length indicator. For example, referring to FIG. 9B, the data container IE 970 may include an identifier (e.g., data container IE identifier 960) and a length indicator 958.

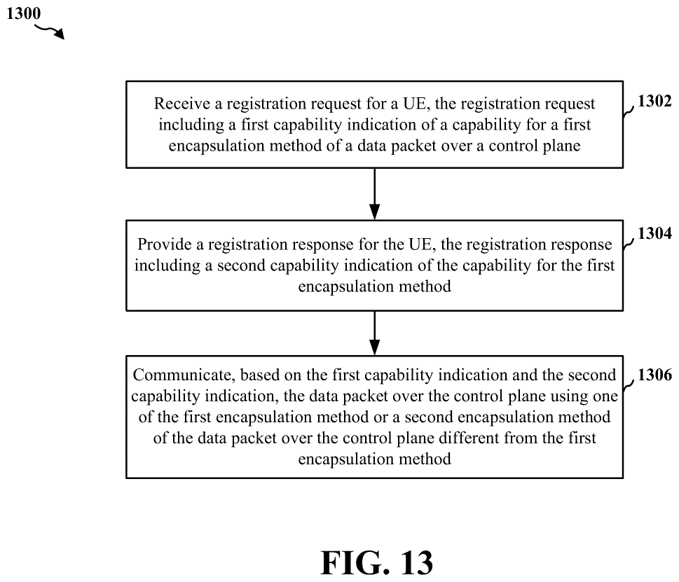

FIG. 13 is a flowchart 1300 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310; network 1004; or the network entity 1502 in the hardware implementation of FIG. 15). The methods significantly reduce the NAS layer overhead for data transmission in connected mode and idle mode of the UE. The methods improve the efficiency of wireless communication. They are particularly beneficial for IoT applications in NTNs, which have limited link budgets, larger delays, and more constrained cell capacities than terrestrial networks.

As shown in FIG. 13, at 1302, the network entity may receive a registration request for a UE. The registration request may include a first capability indication of a capability for a first encapsulation method of a data packet over a control plane. The UE may be the UE 104, 350, 1002, or the apparatus 1504 in the hardware implementation of FIG. 15. FIG. 7A, FIG. 7B, FIG. 7C, FIG. 8A, FIG. 8B, FIG. 9A, FIG. 9B, and FIG. 10 illustrate various aspects of the steps in connection with flowchart 1300. For example, referring to FIG. 10, the network entity (network 1004) may, at 1006, receive a registration request for a UE 1002. The registration request may include a first capability indication of a capability for a first encapsulation method of a data packet over a control plane. In some aspects, 1302 may be performed by the overhead reduction component 199.

At 1304, the network entity may provide a registration response for the UE. The registration response may include a second capability indication of the capability for the first encapsulation method. For example, referring to FIG. 10, the network entity (network 1004) may, at 1008, provide a registration response for the UE 1002. The registration response may include a second capability indication of the capability for the first encapsulation methods. In some aspects, 1304 may be performed by the overhead reduction component 199.

At 1306, the network entity may communicate, based on the first capability indication and the second capability indication, the data packet over the control plane using one of the first encapsulation method or a second encapsulation method of the data packet over the control plane. The second encapsulation method may be different from the first encapsulation method. For example, referring to FIG. 10, the network entity (network 1004) may communicate, at 1020 based on the first capability indication and the second capability indication, the data packet over the control plane using one of the first encapsulation method or a second encapsulation method. For example, when both the UE 1002 and the network 1004 support the first encapsulation method, the network 1004 may communicate the data packet (e.g., data payload 702, 752, 802, 852) based on the first encapsulation method (e.g., the encapsulation structure in FIG. 7A, FIG. 7B, FIG. 7C, FIG. 8A, or FIG. 8B). Otherwise, if one of the UE 1002 or network 1004 does not support the first encapsulation method, the network 1004 may communicate the data packet (e.g., data payload 602, 652) based on the second encapsulation method (e.g., the encapsulation structure in FIG. 6A (e.g., for connected mode) or FIG. 6B (e.g., for idle mode)). In some aspects, 1306 may be performed by the overhead reduction component 199.

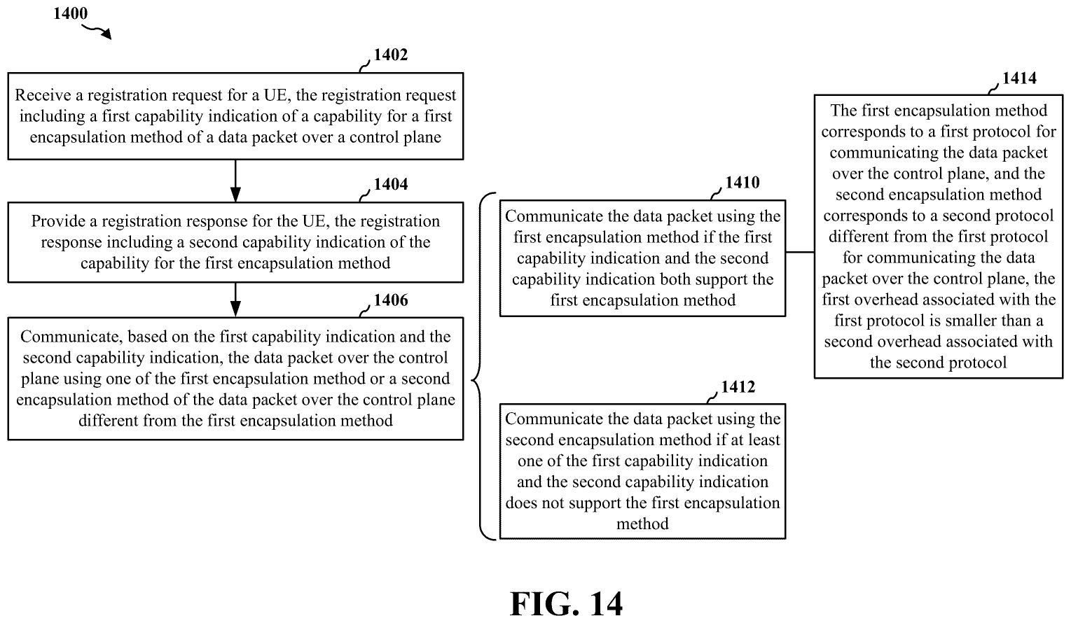

FIG. 14 is a flowchart 1400 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310; network 1004; or the network entity 1502 in the hardware implementation of FIG. 15). The methods significantly reduce the NAS layer overhead for data transmission in connected mode and idle mode of the UE. The methods improve the efficiency of wireless communication. They are particularly beneficial for IoT applications in NTNs, which have limited link budgets, larger delays, and more constrained cell capacities than terrestrial networks.

As shown in FIG. 14, at 1402, the network entity may receive a registration request for a UE. The registration request may include a first capability indication of a capability for a first encapsulation method of a data packet over a control plane. The UE may be the UE 104, 350, 1002, or the apparatus 1504 in the hardware implementation of FIG. 15. FIG. 7A, FIG. 7B, FIG. 7C, FIG. 8A, FIG. 8B, FIG. 9A, FIG. 9B, and FIG. 10 illustrate various aspects of the steps in connection with flowchart 1400. For example, referring to FIG. 10, the network entity (network 1004) may, at 1006, receive a registration request for a UE 1002. The registration request may include a first capability indication of a capability for a first encapsulation method of a data packet over a control plane. In some aspects, 1402 may be performed by the overhead reduction component 199.

At 1404, the network entity may provide a registration response for the UE. The registration response may include a second capability indication of the capability for the first encapsulation method. For example, referring to FIG. 10, the network entity (network 1004) may, at 1008, provide a registration response for the UE 1002. The registration response may include a second capability indication of the capability for the first encapsulation methods. In some aspects, 1404 may be performed by the overhead reduction component 199.

At 1406, the network entity may communicate, based on the first capability indication and the second capability indication, the data packet over the control plane using one of the first encapsulation method or a second encapsulation method of the data packet over the control plane. The second encapsulation method may be different from the first encapsulation method. For example, referring to FIG. 10, the network entity (network 1004) may communicate, at 1020 based on the first capability indication and the second capability indication, the data packet over the control plane using one of the first encapsulation method or a second encapsulation method. For example, when both the UE 1002 and the network 1004 support the first encapsulation method, the network 1004 may communicate the data packet (e.g., data payload 702, 752, 802, 852) based on the first encapsulation method (e.g., the encapsulation structure in FIG. 7A, FIG. 7B, FIG. 7C, FIG. 8A, or FIG. 8B). Otherwise, if one of the UE 1002 or network 1004 does not support the first encapsulation method, the network 1004 may communicate the data packet (e.g., data payload 602, 652) based on the second encapsulation method (e.g., the encapsulation structure in FIG. 6A (e.g., for connected mode) or FIG. 6B (e.g., for idle mode)). In some aspects, 1406 may be performed by the overhead reduction component 199.

In some aspects, to communicate the data packet (at 1406), the network entity may receive or transmit the data packet using the one of the first encapsulation method or the second encapsulation method. For example, referring to FIG. 10, the network entity (network 1004) may, at 1020, receive or transmit the data packet using the one of the first encapsulation method or the second encapsulation method.

In some aspects, the registration request may include one of: an attach request, a tracking area update request, or a registration request message. For example, referring to FIG. 10, the registration request (at 1006) may include one of: an attach request 1022, a tracking area update request 1024, or a registration request message 1026.

In some aspects, the registration response may include one of: an attach response, a tracking area update response, or a registration response message. For example, referring to FIG. 10, the registration response (at 1008) may include one of: an attach response 1032, a tracking area update response 1034, or a registration response message 1036.

In some aspects, to communicate the data packet (at 1406), the network entity may, at 1410, communicate the data packet using the first encapsulation method if the first capability indication and the second capability indication both support the first encapsulation method, or, at 1412, communicate the data packet using the second encapsulation method if at least one of the first capability indication and the second capability indication does not support the first encapsulation method. For example, referring to FIG. 10, when both the UE 1002 and the network 1004 support the first encapsulation method, the network 1004 may communicate the data packet (e.g., data payload 702, 752, 802, 852) based on the first encapsulation method (e.g., the encapsulation structure in FIG. 7A, FIG. 7B, FIG. 7C, FIG. 8A, or FIG. 8B). Otherwise, if one of the UE 1002 or network 1004 does not support the first encapsulation method, the network 1004 may communicate the data packet (e.g., data payload 602, 652) based on the second encapsulation method (e.g., the encapsulation structure in FIG. 6A (e.g., for connected mode) or FIG. 6B (e.g., for idle mode)). In some aspects, 1410 and 1412 may be performed by the overhead reduction component 199.

In some aspects, at 1414, the first encapsulation method may correspond to a first protocol for communicating the data packet over the control plane, and the second encapsulation method may correspond to a second protocol different from the first protocol for communicating the data packet over the control plane. The first overhead associated with the first protocol may be smaller than the second overhead associated with the second protocol. For example, referring to FIG. 7A and FIG. 7B, the first overhead may be associated with the first protocol, and the second overhead may be associated with the second protocol. For example, the first overhead may be 2 octets (bytes) for connected mode and 3 octets (bytes) for idle mode (not counting the security overhead). As shown in FIG. 6A and FIG. 6B, the second overhead may be 8 octets (bytes) for connected mode and 12 octets (bytes) for idle mode (not counting the security overhead). The first overhead may be smaller than the second overhead.

In some aspects, each of the first protocol and the second protocol may be a signaling protocol. For example, referring to FIG. 10, each of the first protocol (associated with the first encapsulation method at 1012) and the second protocol (associated with the second encapsulation method at 1014) may be a signaling protocol.

In some aspects, the second protocol is a NAS protocol. For example, referring to FIG. 10, the second protocol (associated with the second encapsulation method at 1014) may be a NAS protocol.

In some aspects, each of the first protocol and the second protocol may be carried over a signaling radio bearer. For example, referring to FIG. 10, each of the first protocol (associated with the first encapsulation method at 1012) and the second protocol (associated with the second encapsulation method at 1014) may be carried over a signaling radio bearer.

In some aspects, the first overhead may not include an indication of a length of the data packet, and the second overhead may include the indication of the length of the data packet. For example, referring to FIG. 7A, the first overhead (including PD 714, PD 716, EPS bearer ID 704, release assistance indication 706, and the field 708) may not include an indication of the length of the data packet (e.g., data payload 702). On the other hand, referring to FIG. 6A, the second overhead may include the indication of the length of the data packet (e.g., in the user container IE header 603, the ESM message header 606).

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor (or processing circuitry) 1524 (also referred to as a modem) coupled to one or more transceivers 1522 (e.g., cellular RF transceiver). The cellular baseband processor(s) (or processing circuitry) 1524 may include at least one on-chip memory (or memory circuitry) 1524′. In some aspects, the apparatus 1504 may further include one or more subscriber identity modules (SIM) cards 1520 and at least one application processor (or processing circuitry) 1506 coupled to a secure digital (SD) card 1508 and a screen 1510. The application processor(s) (or processing circuitry) 1506 may include on-chip memory (or memory circuitry) 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) (or processing circuitry) 1524 communicates through the transceiver(s) 1522 via one or more antennas 1580 with the UE 104 and/or with an RU associated with a network entity 1502. The cellular baseband processor(s) (or processing circuitry) 1524 and the application processor(s) (or processing circuitry) 1506 may each include a computer-readable medium/memory (or memory circuitry) 1524′, 1506′, respectively. The additional memory modules 1526 may also be considered a computer-readable medium/memory (or memory circuitry). Each computer-readable medium/memory (or memory circuitry) 1524′, 1506′, 1526 may be non-transitory. The cellular baseband processor(s) (or processing circuitry) 1524 and the application processor(s) (or processing circuitry) 1506 are each responsible for general processing, including the execution of software stored on the computer-readable medium/memory (or memory circuitry). The software, when executed by the cellular baseband processor(s) (or processing circuitry) 1524/application processor(s) (or processing circuitry) 1506, causes the cellular baseband processor(s) (or processing circuitry) 1524/application processor(s) (or processing circuitry) 1506 to perform the various functions described supra. The cellular baseband processor(s) (or processing circuitry) 1524 and the application processor(s) (or processing circuitry) 1506 are configured to perform the various functions described supra based at least in part of the information stored in the memory (or memory circuitry). That is, the cellular baseband processor(s) (or processing circuitry) 1524 and the application processor(s) (or processing circuitry) 1506 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1524/application processor(s) (or processing circuitry) 1506 when executing software. The cellular baseband processor(s) (or processing circuitry) 1524/application processor(s) (or processing circuitry) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) (or processing circuitry) 1524 and/or the application processor(s) (or processing circuitry) 1506, and in another configuration, the apparatus 1504 may be the entire UE (e.g., see UE 350 of FIG. 3) and include the additional modules of the apparatus 1504.

As discussed supra, the component 198 may be configured to transmit, for a network entity, a registration request including a first capability indication of a capability for a first encapsulation method of a data packet over a control plane; receive, from the network entity, a registration response including a second capability indication of the capability for the first encapsulation method; and communicate, based on the first capability indication and the second capability indication, the data packet over the control plane using one of the first encapsulation method or a second encapsulation method of the data packet over the control plane different from the first encapsulation method. The component 198 may be further configured to perform any of the aspects described in connection with the flowcharts in FIG. 11 and FIG. 12, and/or performed by the UE 1002 in FIG. 10. The component 198 may be within the cellular baseband processor(s) (or processing circuitry) 1524, the application processor(s) (or processing circuitry) 1506, or both the cellular baseband processor(s) (or processing circuitry) 1524 and the application processor(s) (or processing circuitry) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) (or processing circuitry) 1524 and/or the application processor(s) (or processing circuitry) 1506, includes means for transmitting, for a network entity, a registration request including a first capability indication of a capability for a first encapsulation method of a data packet over a control plane; means for receiving, from the network entity, a registration response including a second capability indication of the capability for the first encapsulation method; and means for communicating, based on the first capability indication and the second capability indication, the data packet over the control plane using one of the first encapsulation method or a second encapsulation method of the data packet over the control plane different from the first encapsulation method. The apparatus 1504 may further include means for performing any of the aspects described in connection with the flowcharts in FIG. 11 and FIG. 12, and/or aspects performed by the UE 1002 in FIG. 10. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

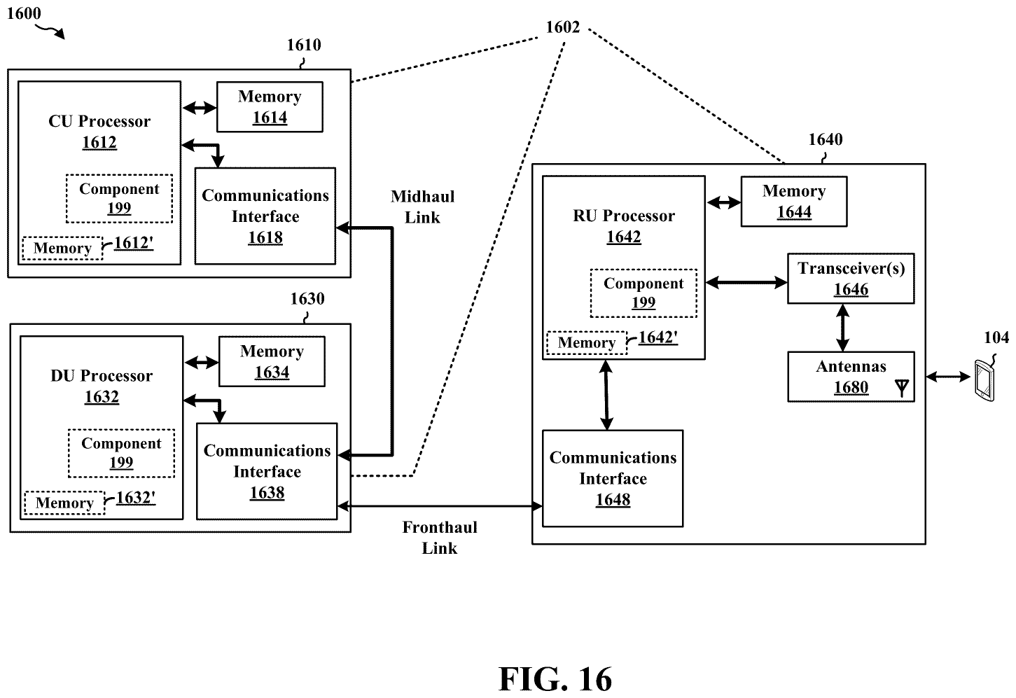

FIG. 16 is a diagram 1600 illustrating an example of a hardware implementation for a network entity 1602, which may also be referred to as a network node. The network entity 1602 may be a BS, a component of a BS, or may implement BS functionality. The network entity may comprise, or be comprised in a base station or more components of a base station, such as the base station 102, 310, or eNodeB 504, among other examples. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor (or processing circuitry) 1612. The CU processor(s) (or processing circuitry) 1612 may include on-chip memory (or memory circuitry) 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor (or processing circuitry) 1632. The DU processor(s) (or processing circuitry) 1632 may include on-chip memory (or memory circuitry) 1632′. In some aspects, the DU 1630 may further include additional memory modules 1634 and a communications interface 1638. The DU 1630 communicates with the RU 1640 through a fronthaul link. The RU 1640 may include at least one RU processor (or processing circuitry) 1642. The RU processor(s) (or processing circuitry) 1642 may include on-chip memory (or memory circuitry) 1642′. In some aspects, the RU 1640 may further include additional memory modules 1644, one or more transceivers 1646, antennas 1680, and a communications interface 1648. The RU 1640 communicates with the UE 104. The on-chip memory (or memory circuitry) 1612′, 1632′, 1642′ and the additional memory modules 1614, 1634, 1644 may each be considered a computer-readable medium/memory (or memory circuitry). Each computer-readable medium/memory (or memory circuitry) may be non-transitory. Each of the processors (or processing circuitry) 1612, 1632, 1642 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to receive a registration request for a user equipment (UE), the registration request including a first capability indication of a capability for a first encapsulation method of a data packet over a control plane; provide a registration response for the UE, the registration response including a second capability indication of the capability for the first encapsulation method; and communicate, based on the first capability indication and the second capability indication, the data packet over the control plane using one of the first encapsulation method or a second encapsulation method of the data packet over the control plane different from the first encapsulation method. The component 199 may be further configured to perform any of the aspects described in connection with the flowcharts in FIG. 13 and FIG. 14, and/or performed by the network 1004 in FIG. 10.

The component 199 may be within one or more processors (or processing circuitry) of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 includes means for receiving a registration request for a user equipment (UE), the registration request including a first capability indication of a capability for a first encapsulation method of a data packet over a control plane; means for providing a registration response for the UE, the registration response including a second capability indication of the capability for the first encapsulation method; and means for communicating, based on the first capability indication and the second capability indication, the data packet over the control plane using one of the first encapsulation method or a second encapsulation method of the data packet over the control plane different from the first encapsulation method. The network entity 1602 may further include means for performing any of the aspects described in connection with the flowcharts in FIG. 13 and FIG. 14, and/or aspects performed by the network 1004 in FIG. 10. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include transmitting, for a network entity, a registration request including a first capability indication of a capability for a first encapsulation method of a data packet over a control plane; receiving, from the network entity, a registration response including a second capability indication of the capability for the first encapsulation method; and communicating, based on the first capability indication and the second capability indication, the data packet over the control plane using one of the first encapsulation method or a second encapsulation method of the data packet over the control plane different from the first encapsulation method. The methods significantly reduce the NAS layer overhead for data transmission in connected mode and idle mode of the UE. The methods improve the efficiency of wireless communication. They are particularly beneficial for IoT applications in NTNs, which have limited link budgets, larger delays, and more constrained cell capacities than terrestrial networks.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is a method of wireless communication at a UE. The method includes transmitting, for a network entity, a registration request comprising a first capability indication of a capability for a first encapsulation method of a data packet over a control plane; receiving, from the network entity, a registration response comprising a second capability indication of the capability for the first encapsulation method; and communicating, based on the first capability indication and the second capability indication, the data packet over the control plane using one of the first encapsulation method or a second encapsulation method of the data packet over the control plane different from the first encapsulation method.

Aspect 2 is the method of aspect 1, wherein communicating the data packet may include transmitting or receiving the data packet using the one of the first encapsulation method or the second encapsulation method.

Aspect 3 is the method of any of aspects 1 to 2, wherein the registration request may include one of: an attach request, a tracking area update request, or a registration request message.

Aspect 4 is the method of any of aspects 1 to 2, wherein the registration response may include one of: an attach response, a tracking area update response, or a registration response message.

Aspect 5 is the method of any of aspects 1 to 4, where the method may further include encapsulating the data packet using the first encapsulation method if the first capability indication and the second capability indication both support the first encapsulation method, or encapsulating the data packet using the second encapsulation method if at least one of the first capability indication and the second capability indication does not support the first encapsulation method

Aspect 6 is the method of aspect 5, wherein the first encapsulation method is associated with a first overhead type, and the second encapsulation method is associated with a second overhead type.

Aspect 7 is the method of aspect 6, wherein the first overhead type may correspond to a first protocol for communicating the data packet over the control plane, and the second overhead type may correspond to a second protocol different from the first protocol for communicating the data packet over the control plane, wherein a first overhead associated with the first protocol may be smaller than a second overhead associated with the second protocol.

Aspect 8 is the method of aspect 7, wherein each of the first protocol and the second protocol may be a signaling protocol, and wherein the second protocol may be a non-access stratum (NAS) protocol.

Aspect 9 is the method of aspect 8, wherein each of the first protocol and the second protocol may be carried over a signaling radio bearer.

Aspect 10 is the method of aspect 7, wherein the first overhead may not include an indication of a length of the data packet, and the second overhead may include the indication of the length of the data packet.

Aspect 11 is the method of aspect 7, wherein the method may include: encapsulating the data packet using the first encapsulation method, and the first overhead may include a protocol descriptor (PD) indicating the first protocol.

Aspect 12 is the method of aspect 11, wherein the first protocol may be dedicated to carrying data over the control planes.

Aspect 13 is the method of aspect 12, wherein the first overhead may include a release assistance indication field, and a size of the release assistance indication field may be less than one byte.

Aspect 14 is the method of aspect 13, wherein the size of the release assistance indication field may be two bits.

Aspect 15 is the method of aspect 6, wherein the method may include: encapsulating the data packet using the first encapsulation method, and the first encapsulation method may have a smaller number of encapsulation layers than the second encapsulation method.

Aspect 16 is the method of aspect 15, wherein encapsulating the data packet using the first encapsulation method may include: encapsulating the data packet in a data container information element (IE).

Aspect 17 is the method of aspect 16, wherein the data container IE may have a first field for an evolved packet system (EPS) bearer identifier (ID) and a second field for release assistance indication.

Aspect 18 is the method of aspect 16, wherein the data container IE may include an identifier and a length indicator.

Aspect 19 is an apparatus for wireless communication at a UE, comprising: a processing system that includes processor circuitry and memory circuitry that stores code and is coupled with the processor circuitry, the processing system configured to cause the UE to perform the method of one or more of aspects 1-18.

Aspect 20 is an apparatus for wireless communication at a UE, comprising: at least one memory; and at least one processor coupled to the at least one memory, the at least one processor is configured to perform the method of any of aspects 1-18.

Aspect 21 is the apparatus for wireless communication at a UE, comprising means for performing each step in the method of any of aspects 1-18.

Aspect 22 is an apparatus of any of aspects 19-21, further comprising a transceiver configured to receive or to transmit in association with the method of any of aspects 1-18.

Aspect 23 is a computer-readable medium (e.g., a non-transitory computer-readable medium) storing computer executable code at a UE, the code when executed by at least one processor causes the at least one processor to perform the method of any of aspects 1-18.

Aspect 24 is a method of wireless communication at a network entity. The method includes receiving a registration request for a user equipment (UE), the registration request comprising a first capability indication of a capability for a first encapsulation method of a data packet over a control plane; providing a registration response for the UE, the registration response comprising a second capability indication of the capability for the first encapsulation method; and communicating, based on the first capability indication and the second capability indication, the data packet over the control plane using one of the first encapsulation method or a second encapsulation method of the data packet over the control plane different from the first encapsulation method.

Aspect 25 is the method of aspect 24, wherein communicating the data packet includes receiving or transmitting the data packet using the one of the first encapsulation method or the second encapsulation method.

Aspect 26 is the method of any of aspects 24 to 25, wherein the registration request includes one of: an attach request, a tracking area update request, or a registration request message.

Aspect 27 is the method of any of aspects 24 to 25, wherein the registration response includes one of: an attach response, a tracking area update response, or a registration response message.

Aspect 28 is the method of any of aspects 24 to 27, wherein communicating the data packet includes: communicating the data packet using the first encapsulation method if the first capability indication and the second capability indication both support the first encapsulation method, or communicating the data packet using the second encapsulation method if at least one of the first capability indication and the second capability indication does not support the first encapsulation method.

Aspect 29 is the method of aspect 28, wherein the first encapsulation method is associated with a first overhead type, and the second encapsulation method is associated with a second overhead type.

Aspect 30 is the method of aspect 29, wherein the first overhead type corresponds to a first protocol for communicating the data packet over the control plane, and the second overhead type corresponds to a second protocol different from the first protocol for communicating the data packet over the control plane, wherein a first overhead associated with the first protocol is smaller than a second overhead associated with the second protocol.

Aspect 31 is the method of aspect 30, wherein each of the first protocol and the second protocol is a signaling protocol, and wherein the second protocol is a non-access stratum (NAS) protocol.

Aspect 32 is the method of aspect 31, wherein each of the first protocol and the second protocol is carried over a signaling radio bearer.

Aspect 33 is the method of aspect 31, wherein the first overhead does not include an indication of a length of the data packet, and the second overhead includes the indication of the length of the data packet.

Aspect 34 is an apparatus for wireless communication at a network entity, comprising: a processing system that includes processor circuitry and memory circuitry that stores code and is coupled with the processor circuitry, the processing system configured to cause the network entity to perform the method of one or more of aspects 24-33.

Aspect 35 is an apparatus for wireless communication at a network entity, comprising: at least one memory; and at least one processor coupled to the at least one memory and, where the at least one processor is configured to perform the method of any of aspects 24-33.

Aspect 36 is the apparatus for wireless communication at a network entity, comprising means for performing each step in the method of any of aspects 24-33.

Aspect 37 is an apparatus of any of aspects 36-38, further comprising a transceiver configured to receive or to transmit in association with the method of any of aspects 24-33.

Aspect 38 is a computer-readable medium (e.g., a non-transitory computer-readable medium) storing computer executable code at a network entity, the code when executed by at least one processor causes the at least one processor to perform the method of any of aspects 24-33.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to cause the UE to:
transmit, for a network entity, a registration request comprising a first capability indication of a capability for a first encapsulation method of a data packet over a control plane;
receive, from the network entity, a registration response comprising a second capability indication of the capability for the first encapsulation method; and
communicate, based on the first capability indication and the second capability indication, the data packet over the control plane using one of the first encapsulation method or a second encapsulation method of the data packet over the control plane different from the first encapsulation method.

2. The apparatus of claim 1, further comprising a transceiver coupled to the at least one processor, wherein to transmit the registration request, the at least one processor is configured to cause the UE to transmit the registration request via the transceiver, and wherein to communicate the data packet, the at least one processor is configured to cause the UE to:
transmit or receive the data packet using the one of the first encapsulation method or the second encapsulation method.

3. The apparatus of claim 1, wherein the registration request includes one of:
an attach request,
a tracking area update request, or
a registration request message.

4. The apparatus of claim 1, wherein the registration response includes one of:
an attach response,
a tracking area update response, or
a registration response message.

5. The apparatus of claim 1, wherein the at least one processor is further configured to cause the UE to:
encapsulate the data packet using the first encapsulation method if the first capability indication and the second capability indication both support the first encapsulation method, or
encapsulate the data packet using the second encapsulation method if at least one of the first capability indication and the second capability indication does not support the first encapsulation method.

6. The apparatus of claim 5, wherein the first encapsulation method is associated with a first overhead type, and the second encapsulation method is associated with a second overhead type.

7. The apparatus of claim 6, wherein the first overhead type corresponds to a first protocol for communicating the data packet over the control plane, and the second overhead type corresponds to a second protocol different from the first protocol for communicating the data packet over the control plane, wherein a first overhead associated with the first protocol is smaller than a second overhead associated with the second protocol.

8. The apparatus of claim 7, wherein each of the first protocol and the second protocol is a signaling protocol, and wherein the second protocol is a non-access stratum (NAS) protocol.

9. The apparatus of claim 8, wherein each of the first protocol and the second protocol is carried over a signaling radio bearer.

10. The apparatus of claim 7, wherein the first overhead does not include an indication of a length of the data packet, and the second overhead includes the indication of the length of the data packet.

11. The apparatus of claim 7, wherein the at least one processor is configured to cause the UE to:
encapsulate the data packet using the first encapsulation method, and the first overhead includes a protocol descriptor (PD) indicating the first protocol.

12. The apparatus of claim 11, wherein the first protocol is dedicated to carrying data over the control plane.

13. The apparatus of claim 12, wherein the first overhead includes a release assistance indication field, and a size of the release assistance indication field is less than one byte.

14. The apparatus of claim 13, wherein the size of the release assistance indication field is two bits.

15. The apparatus of claim 6, wherein the at least one processor is further configured to cause the UE to:
encapsulate the data packet using the first encapsulation method, and the first encapsulation method has a smaller number of encapsulation layers than the second encapsulation method.

16. The apparatus of claim 15, wherein to encapsulate the data packet using the first encapsulation method, the at least one processor is configured to cause the UE to:
encapsulate the data packet in a data container information element (IE).

17. The apparatus of claim 16, wherein the data container IE has a first field for an evolved packet system (EPS) bearer identifier (ID) and a second field for release assistance indication.

18. The apparatus of claim 16, wherein the data container IE includes an identifier and a length indicator.

19. An apparatus for wireless communication at a network entity, comprising:
at least one memory; and
at least one processor coupled to the at least one memory and, based at least in part on information stored in the at least one memory, the at least one processor is configured to cause the network entity to:
receive a registration request for a user equipment (UE), the registration request comprising a first capability indication of a capability for a first encapsulation method of a data packet over a control plane;
provide a registration response for the UE, the registration response comprising a second capability indication of the capability for the first encapsulation method; and
communicate, based on the first capability indication and the second capability indication, the data packet over the control plane using one of the first encapsulation method or a second encapsulation method of the data packet over the control plane different from the first encapsulation method.

20. A method of wireless communication at a user equipment (UE), comprising:
transmitting, for a network entity, a registration request comprising a first capability indication of a capability for a first encapsulation method of a data packet over a control plane;
receiving, from the network entity, a registration response comprising a second capability indication of the capability for the first encapsulation method; and
communicating, based on the first capability indication and the second capability indication, the data packet over the control plane using one of the first encapsulation method or a second encapsulation method of the data packet over the control plane different from the first encapsulation method.
